(19) United States
(12) Patent Application Publication
(10) Pub. No.: US 2025/0361456 A1
(43) Pub. Date: Nov. 27, 2025

(54) GEL BLOCKS WITH LUBRICIOUS SURFACES

(71) Applicant: CommScope Technologies LLC, Hickory, NC (US)

(72) Inventor: Matthew Peter GALLA, Holly Springs, NC (US)

(73) Assignee: CommScope Technologies LLC, Hickory, NC (US)

(21) Appl. No.: 18/866,878

(22) PCT Filed: May 10, 2023
(86) PCT No.: PCT/US2023/021755

§ 371 Date: Nov. 18, 2024

Related U.S. Application Data
(60) Provisional application No. 63/343,406, filed on May 18, 2022.

(51) Int. Cl. C10M 107/50; C10M 107/06; C10M 177/00; C10N 50/08; C10N 70/00

(52) U.S. Cl. CPC C10M 107/50; C10M 107/06; C10M 177/00; C10M 2205/143; C10M 2229/025; C10N 2050/08; C10N 2070/00

(57) ABSTRACT

Methods and compositions for preparing an elastomeric gel block comprising a lubricious surface are provided. A closure or interconnect system sealed with the elastomeric gel block comprising a lubricious surface can exhibit reduced adhesiveness, reduced tack time, and requires substantially reduced force to re-open the closure or interconnect system.

### CROSS-REFERENCE TO RELATED APPLICATIONS

This application is being filed on May 10, 2023, as a PCT International application and claims the benefit of and priority to U.S. Provisional Application No. 63/343,406, filed May 18, 2022, the disclosure of which is hereby incorporated by reference in its entirety.

### BACKGROUND

Telecommunications systems typically employ a network of telecommunications cables capable of transmitting large volumes of data and voice signals over relatively long distances. The telecommunications cables can include fiber optic cables, electrical cables, or combinations of electrical and fiber optic cables. A typical telecommunication network also includes a plurality of telecommunications enclosures and interconnect systems integrated throughout the network of telecommunications cables. Telecommunications enclosures and interconnect systems are typically sealed to inhibit the intrusion of moisture or other contaminants. Silicone gel blocks or thermoplastic gel blocks can exhibit desirable physical properties for use as sealants in closure or interconnect systems.

The ability of a surface of a gel block to slide against any part of the environmental seal is important for enabling efficient sealing with the least compression. Traditional thermoplastic (TPE) gels have sufficient oil bleed out such that surfaces of a gel block under pressure become lubricious and conform well to cable and sealing systems. Newer low oil bleed out (LOBO) TPE gels and “dry” silicone gels suffer from a lack of an oily layer to provide this lubriciousness.

Another problem with softer gels used in cable gel seal arrangements as well as for sealing enclosures is that the gels may be subject to significant tackiness. For example, some gel blocks may suffer from a high level of tackiness/stickiness which may increase the softer the gel becomes. Consequently, handling of the gel blocks may become difficult. For example, when some gel seals are formulated at a low enough hardness to seal effectively over a variety of cable sizes and geometries, the surface of the gel may become tacky. It may be relatively easy to handle gel block seals initially upon installation of the cables and activate the seal by shutting the closure; however, after aging, the seals may become difficult to separate from the cables, each other, and to the areas of the closure to which the seals conform. Also, re-entry of fiber optic closures in the field after first installation may be difficult in view of the tackiness/stickiness. Re-entry may be important in some applications because a fiber optic network is constantly changing and additional customers may need to be added over time. Improved gel block seal configurations, methods and compositions for improving lubricity of gel block surfaces and reducing tack and/or reduced adhesiveness are desirable.

### SUMMARY

The present disclosure provides a method for providing an elastomeric gel block comprising a lubricious surface, the method comprising coating an elastomeric gel block to provide a liquid infused surface treatment (LIS). The LIS treatment provides for a permanent or semi-permanent layer of liquid held in place by surface structures and/or surface particles. Such coatings are typically employed to enable complete de-wetting of liquids from solids. In the present disclosure, the coating may be applied to low hardness, viscoelastic solid gel blocks to enable them to slide along other surface solids such as gel retention components, cables, closures walls, and the like, to enable sealing at low compression. The LIS treatment may also reduce tackiness of the gel blocks to improve handling and re-entry of closures and interconnect systems.

The elastomeric gel block comprising a lubricious surface may be prepared by providing an elastomeric gel block; texturizing at least one surface of the gel block; and treating a surface of the gel block with an LIS liquid by spin coating, spraying, painting, or brushing the LIS liquid onto the surface of the gel block.

The elastomeric gel block comprising a lubricious surface may exhibit one or more of a roll off angle of no more than about 5 degrees; an adhesiveness of no more than 2.5 mJ, or no more than 2.0 mJ, when measured by texture analyzer; a negative adhesive force of no more than 200 g, or no more than 170 g when measured by texture analyzer; and/or a tack time of no more than 1.0 seconds, or no more than 0.8 seconds when measured by texture analyzer.

A closure or interconnect system is provided comprising the elastomeric gel block comprising a lubricious surface of the disclosure, wherein the closure or interconnect system is sealed with the elastomeric gel block comprising a lubricious surface of the disclosure and requires no more than 10 lbf (<44 N), or no more than 5 lbf (<22 N) to re-open the closure or interconnect system.

### BRIEF DESCRIPTION OF THE DRAWINGS

FIG. 1 shows an exemplary schematic illustration of an elastomeric gel block having a lubricious surface. The system includes an elastomeric gel block substrate 110 and an liquid-infused surface (LIS) 120 comprising an impregnating liquid 160, and optionally a solid particle 140 and optionally an additive 180. The contact liquid 190 may be water, or other undesirable contaminating environmental fluid. The contact solid may be a cable, untreated elastomeric gel block surface, closure surface, or interconnect surface in an electrical or telecommunications closure or interconnect system.

FIG. 2 shows a process flow diagram for preparing liquid infused surface (LIS) via a single-step approach, according to an embodiment.

FIG. 3 shows a process flow diagram for preparing liquid infused surface (LIS) via a multi-step approach, according to an embodiment.

### DETAILED DESCRIPTION

Closure systems are used to protect internal components from degradation caused by external environments. For example, internal components such as fiber optic cables and copper cables are often enclosed in closure systems. Other closure systems are commercially available for use with communication and energy transmission cables. Closure systems typically include internal components such as fiber organizers, cable seals and termination devices, drop cable seals for a number of drops with drop cable termination devices, and universal splice holders for a number of splices. These internal components may be subject to environmental factors such as varying moisture levels, heat and cold, and exposure to other chemical substances. The closure systems are preferably protected from damage with a sealant of some sort.

Sealants are often used in closure systems for insulation and for protection against water, corrosion and environmental degradation, and for thermal management. Sealants suitable or closure systems may include thermoplastic gels or thermoset gels. Thermoset gels such as silicone gels or polyurethane gels may be employed in closure systems. Thermoset gels can be produced by chemical crosslinking.

The present disclosure provides gel blocks and gel block seals exhibiting one or more of reduced tackiness, reduced adhesiveness, reduced coefficient of friction, and a roll off angle of less than about 5 degrees, for use in electronic and telecommunications systems such as, for example, cable sealing arrangements, sealing closures, fiber optic organizers, or interconnect systems. For example, gel blocks of the present disclosure may be employed in cable sealing arrangements found in WO 2021/096859, which is incorporated by reference herein in its entirety. For example, gel blocks of the present disclosure may be employed in sealed closures and fiber optic organizers of WO 2019/160995 A9, which is incorporated by reference herein in its entirety.

Gel blocks having a lubricious surface are provided herein for use in sealing closure or interconnect systems. The gel blocks may be thermoset gel blocks or thermoplastic gel blocks.

As used herein, terms such as “typically” are not intended to limit the scope of the claimed invention or to imply that certain features are critical, essential, or even important to the structure or function of the claimed invention. Rather, these terms are merely intended to highlight alternative or additional features that may or may not be utilized in a particular aspect of the present invention.

As used herein, the terms “comprise(s),” “include(s),” “having,” “has,” “contain(s),” and variants thereof, are intended to be open-ended transitional phrases, terms, or words that do not preclude the possibility of additional acts or structure.

Any concentration range, percentage range, or ratio range recited herein are to be understood to include concentrations, percentages, or ratios of any integer within that range and fractions thereof, such as one tenth and one hundredth of an integer, unless otherwise indicated. Also, any number range recited herein relating to any physical feature are to be understood to include any integer within the recited range, unless otherwise indicated.

The terms “a” and “an” as used above and elsewhere herein refer to “one or more” of the enumerated components. For example, “a” polymer refers to one polymer or a mixture comprising two or more polymers.

The term “and/or” refers to and encompasses any and all possible combinations of one or more of the associated listed items.

As used herein, the term “about” means within ten percent (10%) of the given value, either ten percent more than the given amount or ten percent less than the given amount, or both.

As used herein, the term “composition” refers to one or more of a compound, mixture, blend, alloy, polymer and/or copolymer.

The term “centiStokes” (mm²/s, cSt) may be used as a measure of kinematic viscosity. Viscosity is a measurement of a fluids resistance to flow.

The term “centipoise” (10-3 N s/m2, cP) may be used as a measure of absolute viscosity. Conversion of absolute (dynamic) viscosity to kinematic viscosity depends on fluid density. Values of cSt from 1-200,000 may be similar to cP for fluids having density like water, or specific gravity of 1.

As provide herein, ranges are intended to include, at least, the numbers defining the bounds of the range.

Unless otherwise specified, % values refer to weight %.

The term “ambient room temperature” refers to 20-25° C. (68-77° F.).

The term “alkyl” refers to C₁-C₂₀ saturated straight chain or branched alkyl groups. The alkyl group may be C₁-C₆, C₂-C₁₈, C₄-C₁₆, or C₆-C₁₂, for example methyl, ethyl, propyl, isopropyl, n-butyl, sec-butyl, iso-butyl, t-butyl, n-pentyl, sec-pentyl, isopentyl, and the like.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this disclosure belongs. In the event of conflicting terminology, the present specification is controlling. All patents, patent applications and publications referred to herein are incorporated by reference in their entirety.

The term “thermoplastic” refers to a polymer that softens when exposed to heat and returns to a more rigid condition when cooled. These polymers can typically go through repeated melting and freezing cycles, and can be reshaped upon reheating.

The term “elastomer” refers to a polymer that displays rubber-like elasticity. (Pure Appl. Chem., Vol. 79, No. 10, pp. 1801-1829, 2007, p. 1810) Elastomers exhibit viscoelasticity (having both viscosity and elasticity) and weak inter-molecular forces, generally having low Young's modulus and high failure strain compared with other materials.

The term “thermoplastic elastomer” refers to an elastomer comprising a thermoreversible network. (IUPAC Recommendations 2007-Pure Appl. Chem., Vol. 79, No. 10, pp. 1801-1829, 2007, p. 1811). Thermoplastic elastomers (TPE), sometimes referred to as thermoplastic rubbers, are a class of copolymers or a physical mix of polymers which include materials with both thermoplastic and elastomeric properties.

The term “gel” refers to a non-fluid colloidal network or polymer network that is expanded throughout its whole volume by a fluid. (IUPAC Recommendations 2007, Pure Appl. Chem., Vol. 79, No. 10, pp. 1801-1829, p. 1806). For example, a gel may be a non-crystalline, non-glassy solid material composed of a liquid organic phase entrapped in a three-dimensionally cross-linked network.

The term “Mn” refers to number average molecular weight. Mn is the statistical average molecular weight of all the polymer chains in the sample, where Mn=ΣNiMi/ΣNi, where Mi is the molecular weight of a chain and Ni is the number of chains of that molecular weight.

The term “Mw” refers to weight average molecular weight. Compared to Mn, Mw takes into account the molecular weight of a chain in determining contributions to the molecular weight average. The more massive the chain, the more the chain contributes to Mw.

A closure or interconnect system is provided comprising a gel block having a lubricious surface as provided herein, for example, wherein the closure or interconnect system is capable of sealing within 5 minutes after opening and closing to reseal to 20 kPa pressure.

A gel block comprising a lubricious surface is provided for use in an enclosure to seal cable entry/exit locations, the gel block comprising a gel block material that may have a residual indentation hardness ranging from 20 g-150 g; a compression set of less than 10% after 20 or 10 minutes of recovery time; an elongation to failure of at least 500%; a resistance to extrusion having a measured volume of no more than 0.5 cm³; and an oil bleed-out of less than 20% or 15% after 21 days. The gel block material may be a thermoset material or a thermoplastic elastomer material.

### Gel Blocks

In the present disclosure, the gel block may comprise any appropriate gel for use in sealing telecommunications closures.

The gel may be a thermoset gel, e.g., a silicone gel, in which the crosslinks are formed through the use of multifunctional crosslinking agents, or the gel may be a thermoplastic gel, in which microphase separation of domains serves as junction points. Thermoplastic elastomers, unlike thermoset elastomers, can be processed using melt processing techniques.

Suitable gels include those comprising silicone, e.g., a polyorganosiloxane system, as well as polyurethane, polyurea, styrene-butadiene copolymers, styrene-isoprene copolymers, styrene-(ethylene/propylene)-styrene (SEPS) block copolymers (available under the tradename Septon™ by Kuraray), styrene-(ethylene-propylene/ethylene-butylene)-styrene block copolymers (available under the tradename Septon.™. by Kuraray), and/or styrene-(ethylene/butylene)-styrene (SEBS) block copolymers (available under the tradename Kraton™ by Shell Oil Co.). Suitable extender fluids may include mineral oil, vegetable oil, paraffinic oil, silicone oil, plasticizer such as trimellitate, or a mixture of these, when present may be generally in an amount of 30 to 90% by volume of the total weight of the gel.

### Silicone Gels

Silicone gel blocks having a lubricious surface are provided for use in sealing closure or interconnect systems.

The silicone gels of the disclosure may be made according to a number of different polymerization reactions with optional further addition of a non-reactive silicone oil. The polymerization reaction may be a hydrosilylation reaction, also referred to as a hydrosilation reaction. The hydrosilylation reaction may makes use of a platinum catalyst, while other embodiments make use of radicals. In further embodiments, the silicone gel is made by a dehydrogenated coupling reaction. In other embodiments, the silicone gel is made by a condensation cure RTV reaction.

The silicone gels may be made by reacting at least a crosslinker, a chain extender, and a base polymer (e.g., a vinyl-terminated polydimethylsiloxane), optionally in the presence of non-reactive silicone oil. In some examples, the silicone gels may be made from formulations comprising a divinyl terminated polydimethyl siloxane as a base polymer, a chain extender, a cross linker, and a non-reactive PDMS silicone fluid.

A catalyst may be included to speed up the reaction. In some examples, an inhibitor may be used to slow down the rate of reaction. Exemplary components of the silicone gels, their resulting properties, and their end-use are described in greater detail below.

The silicone gel may be made by an addition cure or platinum cure reaction mechanism. In some embodiments, the mechanism employs the use of a catalyst. By using a catalyst, the activation energy of the reaction is lowered and faster curing times at lower temperatures can be achieved. A schematic overview of the platinum cure reaction mechanism is shown below in Scheme I.

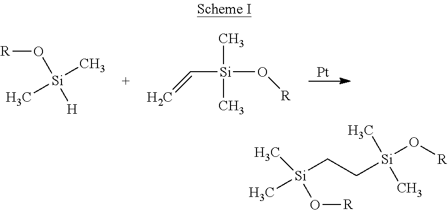

For the reaction in (I) to be made possible, two functional groups must react with each other. In certain embodiments, the two functionalities are (1) the Si—H (hydride) group and (2) the Si-vinyl group. These two functionalities may be provided by: (1) a base polymer, (2) a crosslinker, and (3) a chain extender.

For example, divinyl polydimethyl siloxane compounds of up to 80,000 cSt viscosity may be used with tetra or tri hydride cross linking agents (such as tetrakis dimethyl siloxy silane, SIT 7278 from Gelest for example), and cross link the divinyl using a catalyst, such as a platinum catalyst. The cross link density is kept low by extending the system with non-reactive polydimethyl siloxane (silicone fluid).

For the reaction in (I) to be made possible, two functional groups must react with each other. In certain embodiments, the two functionalities are (1) the Si—H group and (2) the Si-vinyl group. These two functionalities may be provided by: (1) a base polymer, (2) a crosslinker, and (3) a chain extender.

The silicone gel may be a silicone dry gel or a silicone oil gel. The silicone gel may be prepared by any appropriate method known in the art. For example, the silicone gel may be prepared from a silicone gel composition comprising: a base polymer having a vinyl-silicone group; a catalyst; a hydride containing crosslinker; optionally a hydride containing chain extender; and optionally a non-reactive silicone oil.

As used herein, the term “silicone gel” refers to a chemically crosslinked polymer having a Si—O backbone. As opposed to carbon-based polymers, the crosslinked silicone polymers of silicone dry gels are based on a Si—O backbone. The characteristics of silicon and oxygen provide crosslinked polymers with their exceptional properties. For example, silicon forms stable tetrahedral structures, and silicon-oxygen bonds are relatively strong which results in silicone gels with high temperature resistance. In addition, crosslinked Si—O polymers have a relatively high chain flexibility as well as low rotational energy barrier.

As used herein, the term “silicone dry gel” may refer to a chemically crosslinked polymer having a Si—O backbone and comprising a relatively low amount (e.g., <5%, or <10%), or no amount at all, of added diluent fluids such as silicone oil or mineral oil. Silicone dry gels for use in closure or interconnect systems are described in, for example, U.S. Pat. Nos. 8,642,891 and 9,556,336, Berghmans et al. Silicone dry gels may be prepared from a vinyl-terminated polydimethylsiloxane (PDMS), a hydride containing crosslinker, and a hydride containing chain extender. The silicone dry gel may exhibit a hardness in a range between about 40-250 g, 50-150 g, or 60-120 g, and a slow compression set recovery of about 60% compression set at 5 minutes, or about 30% compression set at 30 min. The target hardness is needed to make the gel functional from its sealing perspective.

As used herein, the term “silicone oil gel” may refer to a silicone gel having a chemically crosslinked polymer with a Si—O backbone and comprising an amount of added non-reactive diluent fluids such as silicone oil or mineral oil. The silicone oil may be a non-reactive oil. a non-reactive silicone oil or a mineral oil, for example, in an amount greater than or equal to 5 wt %, for example, from 5-80 wt %, 10-60 wt %, 20-55 wt %, or 30-50 wt %. The non-reactive diluent fluid may be, for example, a polydimethyl siloxane trimethyl (PDMS) terminated silicone oil fluid. Silicone oil gels containing about 10-60 wt % or higher of a non-reactive silicone oil are described in, for example, WO 2021/113109, Commscope Technologies LLC. For example, the silicone oil gel formulations may contain 10-60 wt % of a non-reactive silicone oil, 30-40% divinyl siloxane, 1-2% cross linking agent, and 5-100 ppm catalyst. This type of silicone oil gel may exhibit a residual indentation hardness ranging from 20 g-150 g; a compression set of less than 10% after 20 minutes or 10 minutes of recovery time; an elongation to failure of at least 500%; a resistance to extrusion having a measured volume of no more than 0.5 cm³; and an oil bleed-out of less than 20% or less than 15% after 21 days.

### Silicone Gel Base Polymer

The Si-vinyl group may be provided by a base polymer such as a vinyl terminated polydimethylsiloxane (otherwise referred to as “V-PDMS”), which is shown below in Scheme (II). In this example, the base polymer compound comprises a vinyl group at each end of the compound.

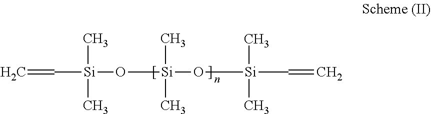

The molecular weight of the base polymer may be controlled through anionic ring-opening polymerization of cyclic siloxanes in the presence of alkali-metal hydroxide of a base that is volatile (e.g., tetramethylammonium silanolate). Endcapping of the PDMS with a vinyl group may be needed, so these groups are added to the polymerization mixture. V-PDMS together with the chain extender may be used to determine the molecular weight between the different crosslink sites.

The vinyl-containing base polymer, such as V-PDMS, may have different viscosities that affect the resulting silicone gel. In general, a high molecular weight V-PDMS may produce an uncured gel with a higher viscosity. In certain embodiments, a low molecular weight V-PDMS may improves processability.

The V-PDMS used in the silicone gel may have a viscosity between approximately 100 and 165,000 cSt (100-165,000 mm²/s), between approximately 1000 and 100,000 cSt (1000-100,000 mm²/s), between approximately 1000 cSt and 60,000 cSt (1000-60,000 mm²/s), between approximately 3000 cSt and 7000 cSt (3000-7000 mm²/s), or between approximately 4500 cSt and 5500 cSt (4500-5500 mm²/s).

The vinyl-terminated polydimethylsiloxane may have an average molecular weight between about 6,000 g/mol and about 170,000 g/mol, between about 28,000 g/mol and about 72,000 g/mol. The vinyl-terminated polydimethylsiloxane may have an average molecular weight of approximately 49,500 g/mol.

The base polymer may contain between approximately 1 and 10 mol of vinyl per 500,000 g/mol of V-PDMS. In one embodiment, the base polymer contains approximately 2 mol of vinyl per mol of V-PDMS. In yet other embodiments, the vinyl content of the V-PDMS is between approximately 0.01 and 0.1 equivalent/kg, or between approximately 0.036 and 0.07 eq/kg, or between approximately 0.04 and 0.05 eq/kg.

The base polymer may be a vinyl containing polydialkylsiloxane, polyalkylarylsiloxane, or polydiarylsiloxane including vinyl polymers and copolymers. For example, the vinyl-containing base polymer may contain any of the following monomers: dimethyl, diethyl, vinylmethyl, diphenyl, phenylmethyl, trifluoropropylmethyl, nonafluorohexamethyl, dimethoxy, and diethoxy. In addition to di-vinyl terminated base polymers, alpha-vinyl, omega-hydride terminated polymers may be employed as a substantial portion of the gel polymer.

The amount of base polymer in the silicone gel composition may be between 40-90 wt %, between 45-80 wt %, or between 50-65 wt %.

### Silicone Gel Crosslinker

The Si—H end groups for the reaction in (I) may be provided by a crosslinker and/or a chain extender. A crosslinker is capable of forming connections between vinyl-terminated polydimethylsiloxane chains. In certain embodiments, the crosslinker includes electronegative substituents such as alkylsiloxy or chlorine. In some embodiments, the crosslinker may have three or four or more Si—H groups that are capable of forming a connection point between three or four different vinyl-terminated polydimethylsiloxane chains, respectively. The crosslinker may have four Si—H groups. For example, the crosslinker may be tetrakis(dimethylsiloxy)silane, shown below in structure (IIIa), or 1,3-diphenyltetrakis(dimethylsiloxy) disiloxane. In other embodiments, the crosslinker may include three Si—H hydride groups, for example, the crosslinker may be methyltris(dimethylsiloxy)silane, shown below in structure (IIIb), or phenyltris(dimethylsiloxy)silane. Other crosslinkers may also be used. Using higher functional crosslinkers is also possible, but these form less defined polymer structures.

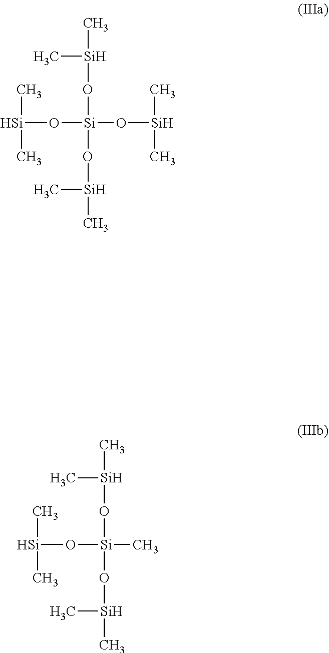

The preferred cross linkers may include Gelest SIT 7278 tetrakis dimethyl siloxy silane and Gelest SIP 6826, phenyl tris dimethyl siloxy silane, but other hydride based cross linkers may also be used. For example, crosslinker may include phenyltris(dimethylsiloxy)silane (e.g., CAS 18027-45-7) to improve tear resistance of the silicone gel.

An alternative multifunctional vinyl cross linker may be used to reduce the steepness of the hardness ratio curve. The advantage of the multifunctional vinyl cross linker is that it can be placed on both sides A and B since the multifunctional vinyl compound will not react with the hydride in the B side without any platinum catalyst. The ability to put some of the multifunctional vinyl compound on the B and/or A side enables the A to B ratio to remain close to 1.00 to 1.00 with varying hardness values, effectively flattening the curve of hardness versus ratio. The alternative cross linker consists of any multifunctional vinyl compound such as a bis(divinyl) terminated polydimethylsiloxane, for example, Gelest DMS-VD11.

### Silicone Gel Chain Extender

In addition to the crosslinker, the Si—H end group may be provided by a chain extender, for example, wherein both ends of the chain extender compound are terminated with a Si—H group. Any difunctional Si—H molecule with good solubility in the base vinyl may be suitable as a chain extender. For example, the chain extender may be a hydride terminated PDMS. Practically speaking, below a certain molecular weight, the dihydride may become too volatile. Chain extenders having about 400-500 g/mol, or about 450 g/mol, or greater, may be employed. Higher molecular weight dihydrides may be employed. For example, dihydrides of similar molecular weight up to the base polymer MW high end of range above may be employed, with some adjustment to account for the resulting differences in molecular weight between crosslinks. Chain extenders (dihydride functional molecules, F=2) may be employed when a low viscosity, low molecular weight base polymer is used, for one purpose in order to increase molecular weight between crosslinks. When higher molecular weight (e.g. >80 k G/mol) base polymers are used, chain extender may not be required.

In certain embodiments, the chain extender comprises reactive groups that are compatible and are willing to react with the vinyl groups in the base polymer. Just as for the crosslinker, these groups are Si—H groups that can react in a hydrosilation reaction. The chain extender typically includes two functional groups; however, the chain extender may include three or more functional groups, such that the chain extender functions as a branching agent. The functional groups may be the same as or different than each other. The functional groups may also be the same as or different than the functional groups of the first component and/or the second component.

The chain extender may be any chain extender known in the art. In one embodiment, the chain extender is a hydride containing polydimethylsiloxane. In another embodiment, the chain extender may be a hydride terminated polydimethylsiloxane, shown below in Structure (IV).

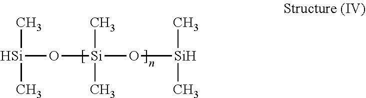

The chain extender may be a hydride terminated polyphenylmethylsiloxane. In another embodiment, the chain extender is a hydride terminated polydiphenylsiloxane. In yet another embodiment, the chain extender is a dihydride containing siloxane. For example, the chain extender may be a hydride terminated PDMS having avg. molecular weight of about 400 to about 62,700 g/mol; or about 400-500 g/mol, about 600-700 g/mol, about 1000-1100 g/mol; about 4000-5000 g/mol; about 17,200 g/mol; about 28,000 g/mol; or about 62,700 g/mol. The chain extender may have a high molecular weight or a low molecular weight. The chain extender may also be branched or unbranched. In other embodiments, the chain extender is a high molecular weight polydimethylsiloxane. In other embodiments, the chain extender is a low molecular weight polydimethylsiloxane of MW 400-500 g/mol.

Considering the full acceptable range of vinyl base polymer, the total dihydride content (based on the molecule referenced) could be as high as 15-20% —this would be for 100 cSt vinyl base polymer. For vinyl base polymers above ˜40 k cSt, dihydride (chain extender) content could be very low-approaching 0%. In some embodiments, silicone gel compositions may use even 0% chain extender.

Optionally, an alkoxy-functionalized siloxane can be included. Suitable alkoxy-functionalized siloxanes include polydiethoxysiloxane, tetraethoxy silane, tetramethoxy silane, and polydimethoxysiloxane (DMS). In other embodiments, the chain extender may be a fluorosilicone, phenyl silicone, or a branching diethyl silicone.

In certain embodiments, by making use of the chain extender molecule, the V-PDMS base polymer can be shorter because the H-PDMS chain extender will extend the V-PDMS base polymer chain in situ between two crosslinker compounds. By using this mechanism, a V-PDMS chain of a shorter length can be applied which leads to lower viscosities and compounds that are easier to work with. Therefore, lower viscosity base polymer compounds can be used unlike a peroxide activated cure reaction mechanism. For example, a peroxide activated cure mechanism makes use of polymer chains with viscosities of approximately 2,000,000 cSt (2,000,000 mm²/s) while in the platinum cure mechanism allows for base polymer chains (V-PDMS) having viscosities of approximately 5,000 cSt (5,000 mm2/s).

### MFHC and H/V Ratios

The amounts of crosslinker and chain extender that provide the hydride component may be varied. In certain embodiments, the amount of hydride in the gel may be defined in terms of the mole fraction of hydride present as crosslinker (“MFHC”). For example, when the MFHC value is 0.3 or 30%, this means that 30% of the hydrides present in the system are part of the crosslinker and the remaining 70% of the hydrides are provided by the chain extender. In certain embodiments, the MFHC ratio may be altered to adjust the hardness of the gel (i.e., an increase in the MFHC may increase the hardness). In certain embodiments, the MFHC value may be greater than 0.2, 0.3, 0.4, or 0.5. In some embodiments, the MFHC value is between 0.2 and 0.5. In other embodiments, the MFHC value is between 0.3 and 0.4.

The overall amount of hydride components in the gel can also vary. The ratio of hydride to vinyl components (for example, provided by the base polymer) can be defined as “H/V.” In other words, H/V is the total moles of hydride (for example, contributions from crosslinker and chain extender) divided by the amount in moles of vinyl from the base polymer (e.g., V-PDMS) present. In certain embodiments, the silicone gel may have a H/V ratio between 0.5 and 1.0, between 0.6 and 1.0, between 0.7 and 1.0, between 0.8 and 1.0, or between 0.9 and 1.0. If the H/V ratio is greater than 1, this means that there are more hydride groups present in the system than vinyl groups. In theory, the silicone gel will have a maximum hardness where the H/V ratio is 1 (this is the theoretical point where all the groups react with each other.) However, in practice this is not always the case and the maximum will be situated in the neighborhood of H/V equals 1.

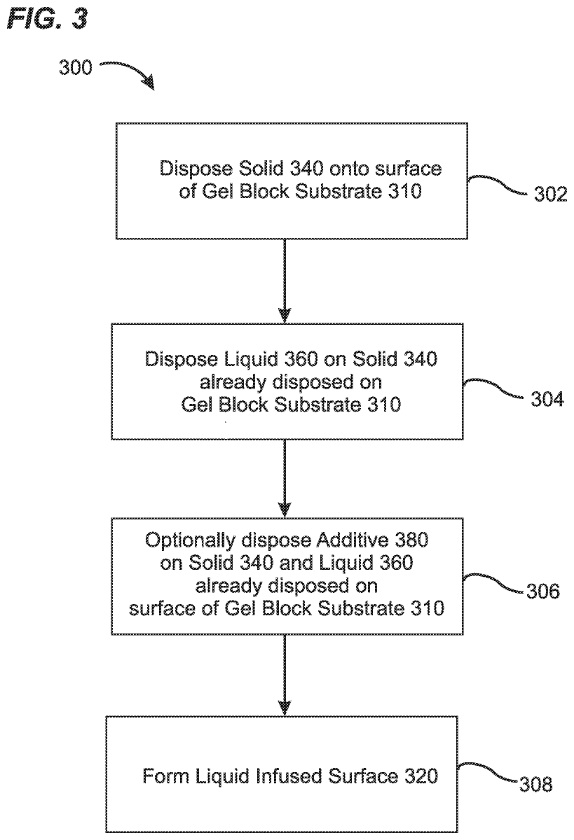

The target hardness of the gel may tailored by adapting the formulation stoichiometry of components A (PDMS vinyl groups) and B (Hydride groups from the crosslinker and extender chains). A theoretical representation depicting the relation between hardness of the silicone gel and the H/V ratio is shown in FIG. 3. In certain embodiments, the region of interest (or “ROI”) for the silicone gel comprises slightly less hydrides than vinyl groups (i.e., the H/V is less than but close to 1). This is because gels with H/V values greater than 1 can undergo undesired post-hardening of the gel. With the help of the stoichiometric curve shown in FIG. 3, the relationship between the amount of hydride groups and the amount of vinyl can be calculated to get a certain hardness. This value can be used to obtain the different amount of reagents needed to make a gel with the wanted hardness. With the addition of non-reactive silicone oil, the amount of crosslinker and/or chain extender may be increased somewhat from the calculated ratio of hydride to vinyl in order to achieve a target hardness.

A schematic overview of the silicone gel reaction is depicted in Scheme (V) below, wherein the crosslinker compounds are represented by “+,” the chain extender compounds are represented by “=,” and the base polymer V-PDMS compounds are represented by “−.” In certain embodiments, the chain extender must always connect two different base polymer compounds, or connect to one base polymer and terminate the chain on the opposite end.

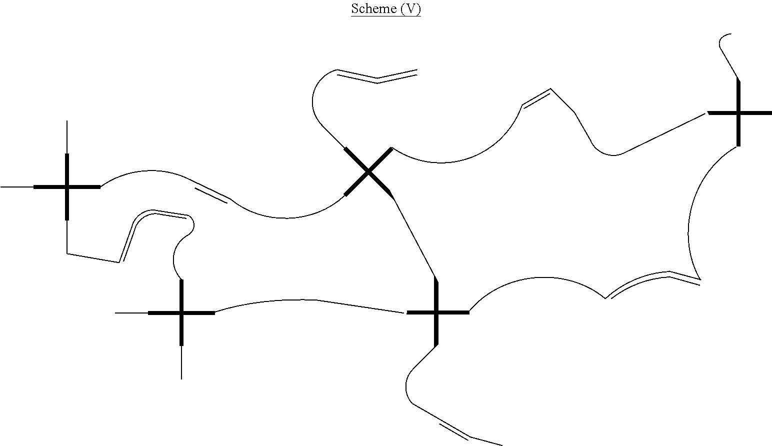

In certain embodiments, an addition cure catalyst is used to assist in reacting the base polymer, crosslinker, and chain extender. Performing the reaction without using a catalyst is typically a very energy consuming process. Temperatures of 300° C., or even higher may be needed in order to avoid the produced gel to have poor and inconsistent mechanical properties.

The catalyst may include a Group VIII metal. In other embodiments, the catalyst comprises platinum. Platinum catalyst can be prepared according to methods disclosed in the art, e.g., Lewis, Platinum Metals Rev., 1997, 41, (2), 66-75, and U.S. Pat. No. 6,030,919, herein incorporated by reference. In another embodiment, the catalyst is a homogenous catalyst. In other embodiments, the catalyst is a heterogeneous catalyst. Examples of heterogeneous catalysts include platinum coated onto carbon or alumina.

The catalyst may be a “Karstedt's catalyst.” This is a platinum catalyst made of Pt complexed with divinyltetramethyldisiloxane, shown below in Structure (VI).

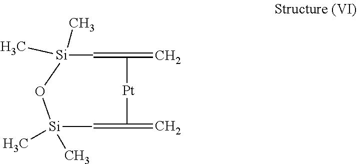

An advantage of this catalyst is the fact that no heterogeneous reaction is taking place but that the catalyst will form a colloid. An advantage of these catalysts is the fact that only a small amount (ppm level) is needed. This reduces the cost of the polymerization process.

The catalyst may be a rhodium chloride complex, e.g., tris(triphenylphosphine) rhodium chloride (“Wilkinson's catalyst”). Rhodium based catalysts may require higher concentrations and higher reaction temperatures to be successful to a large extent. But poisoning comes together with reactivity; and therefore rhodium based catalysts may be less easily poisoned than platinum catalysts.

The catalyst may be a carbonyl derivation of iron, cobalt, and nickel. For example, the catalyst may be dicobaltoctacarbonyl CO₂(CO)₈. High temperatures (e.g., >60° C.) should be avoided in order to prevent decomposition and deactivation of the catalyst. In comparison to the Pt catalyst, here 10⁻³M are needed in the case of Pt which is 10⁻⁶M or ppm level. Also the reactivity is slowed down by a factor of 5.

The catalytic reaction mechanism may be a Lewis-mechanism. First, there is a coordination of oxygen to the catalyst in the presence of the crosslinker or chain extender. This step is called the induction period. This gives hydrogen and the platinum colloid. Next, the chain extender or crosslinker will precede the attack of the vinyl group. By doing this, an electrophile complex is formed. The vinyl group (V-PDMS) then will act as a nucleophile. Combining both the vinyl-group of the V-PDMS chain with the crosslinker or chain extender that was bound to the Pt-catalyst gives the silicone product. The hydride is transferred to the second carbon of the vinyl group. The Pt-colloid is than available for reacting a second time. Oxygen can be seen as a co-catalyst because oxygen is not consumed in this reaction and the O—O is not broken in the reaction sequence.

Catalysts should be isolated from compounds that can poison, or otherwise harm, the catalyst's performance. For example, amines, thiols, and phosphates can all poison a catalyst such as a platinum containing catalyst. Amines, thiols, and phosphates may form very stable complexes with a catalyst, thereby slowing the reaction or altogether stopping the reaction.

### Inhibitor

In certain embodiments, inhibitors are added in the silicone gel formulation to slow down the curing process. Slowing down the curing process allows more time to work with the polymer mixture during processing, dispensing, and molding.

The inhibitor can bind to the catalyst and form a stable complex. By doing this, the Pt catalyst is deactivated. When the complex is activated by adding energy (raising the temperature) the inhibitor will lose its binding for the Pt-catalyst. After this, the Pt-catalyst is in its activated form again and the polymerization reaction can start. The inhibitor may help manipulate the gel before it fully cures and extend the pot life. In certain embodiments, the pot life may be approximately 1 hour at room temperature and 6-8 hours at 3° C.

In certain embodiments, the inhibitor comprises two electron-rich groups (alcohol- and allylfunction) forming an acetylenic alcohol. These groups can interact with the catalyst and shield it from other reactive groups. The inhibitor of a Pt-catalyst may be 3,5-Dimethyl-1-hexyn-3-ol, shown below in Structure (VII).

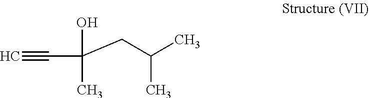

The silicone gel composition may comprise additional common components. For example, the compositions may include additives such as flame retardants, coloring agents, adhesion promoters, stabilizers, fillers, dispersants, flow improvers, plasticizers, slip agents, toughening agents, and combinations thereof. In certain embodiments, the additional additives may include at least one material selected from the group consisting of ethyl polysilicate (Dynasylan 40), diphenylsiloxaone-dimethylsiloxane copolymer (PDM 1922), 1,2-bis(3,5-di-tert-butyl-4-hydroxyhydrocinnamoly) hydrazine (Songnox 1024), Kingnox 76, DHT-4A, Kingsorb, pigment, and mixtures thereof. In some embodiments, the additives comprise between 0.1 and 25 wt % of the overall composition, between 0.1 and 5 wt % of the overall composition, between 0.1 and 2 wt % of the overall composition, or between 0.1 and 1 wt % of the overall composition.

In order to improve tear strength and silicone gels may be optionally toughened by incorporating a silica (SiO₂) reinforcement into the structure. The silica reinforcement may be a fumed silica, precipitated silica, or a structurally-modified silica reinforcement. A silica reinforcement may be employed in the silicone gel in a range of from 0-30 wt %, 1-25 wt %, or 5-20 wt %. For example, hydrophobic fumed silica may be employed for improvement of physical properties. Hydrophilic fumed silica may be employed for modifying the viscosity of the components to produce shear thinning behavior. Typical amount of a fumed silica may be about 0-30 wt %, 10-25 wt %, or 2-20 wt %. For example, a structurally-modified silica (e.g., silane-modified fumed silica, e.g., Aerosil R 8200) may be employed to improve tear strength, for example, in a range of 0-30 wt %, 5-25 wt %, or 10-20 wt %

In some embodiments, the compositions disclosed and by methods disclosed herein comprise a flame retardant. In certain embodiments, the flame retardant is zinc oxide. In some embodiments, the flame retardant comprises between 0.1 and 25 wt % of the overall composition, between 0.1 and 5 wt % of the overall composition, between 0.1 and 2 wt % of the overall composition, or between 0.1 and 1 wt % of the overall composition. In one embodiment, the flame retardant comprises 20 wt % of the overall gel composition.

### Non-Reactive Silicone Oil

The silicone gel composition may contain a non-reactive silicone oil fluid in the first and or second set of components. The non-reactive silicone oil may be an inert polydimethylsiloxane (PDMS). For example, the non-reactive silicone oil may be a trimethylsiloxy terminated PDMS, or a silanol terminated PDMS (Si—OH). Other inert silicone fluids may include diphenylsiloxane-dimethylsiloxane copolymers, phenylmethylsiloxane-dimethylsiloxane copolymers, phenylmethylsiloxane homopolymers, phenylmethylsiloxane-diphenylsiloxane copolymers, alkyl silicones, aryl-alkylsiliconesand fluorosilicone fluids. In some embodiments, the non-reactive silicone oil is a trimethylsiloxy terminated PDMS, for example as shown in Structure (VIII). The non-reactive silicone oil may have kinematic viscosity in a range of from 10 cSt to 30,000 cSt, 20-5,000 cSt, 50-1,000 cSt, or 50-350 cSt at 25° C. The non-reactive silicone oil may be a trimethylsiloxy terminated PDMS having a kinematic viscosity of about 50, about 100, about 200, or about 350 cSt at 25° C.

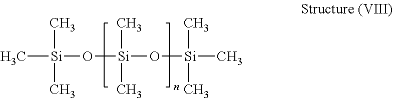

The silicone gels of the disclosure may be prepared by incorporating 10-60%, 20-55%, or 30-50%, 35-45%, or about 40% by volume of a non-reactive silicone oil fluid. The non-reactive silicone oil fluid levels may differentiate the silicone gels of the present disclosure from certain prior art which contain approximately 65% or more by volume fluid and were much lower in hardness and not nearly as strong.

In some embodiments, the compositions disclosed and made by methods disclosed herein contain at least one stabilizer. Stabilizers include antioxidants, acid-scavengers, light and UV absorbers/stabilizers, heat stabilizers, metal deactivators, free radical scavengers, carbon black, and antifungal agents.

The silicone gel may be produced by a method comprising: providing a first set of components comprising: (1) a base polymer having a vinyl-silicone group, (2) an addition cure catalyst, and optionally (3) a non-reactive silicone oil; providing a second set of components comprising: (1) a hydride containing crosslinker, (2) additional base polymer having a vinyl-silicone group, and optionally (3) a non-reactive silicone oil; mixing the first and second set of components together to form a silicone gel composition; molding and curing the silicone gel composition to form the silicone gel. The second set of components may further comprise a chain extender, such as a hydride containing chain extender.

non-reactive silicone oil may be a trimethylsiloxy-terminated or silanol-terminated polydialkylsiloxane. The non-reactive silicone oil may be a trimethylsiloxy-terminated polydimethylsiloxane. The non-reactive silicone oil may have viscosity of between about 10-30,000 cSt (10-30,000 mm2/s), 20-5,000 cSt (20-5,000 mm2/s), 50-1,000 cSt (50-1,000 mm2/s), or 50-350 cSt (50-350 mm2/s). The silicone gel composition may include between about 10-60 wt %, 20-55 wt %, or 30-50 wt % of the non-reactive silicone oil. The base polymer and additional base polymer may each be a vinyl-terminated polydimethylsiloxane. The base polymer and additional base polymer each may have have one or more of the following properties: (a) a molecular weight between 6,000 g/mol and 170,000 g/mol; (b) a viscosity between 100 mm2/s and 165,000 mm2/s; and (c) a vinyl content between 0.01 eq/kg and 0.1 eq/kg.

The base polymer and additional base polymer may each be a vinyl-terminated polydimethylsiloxane. The base polymer and additional base polymer may each have one or more of the following properties: (a) a molecular weight between 6,000 g/mol and 170,000 g/mol; (b) a viscosity between 100 mm2/s and 165,000 mm2/s; and (c) a vinyl content between 0.01 eq/kg and 0.1 eq/kg. The silicone gel composition may include the base polymer and additional base polymer in an amount between 40-90 wt %, between 45-80 wt %, or between 50-65 wt %.

The crosslinker may have >2 or <10 Si—H hydride moieties per molecule. The crosslinker may have three or four Si—H hydride moieties per molecule. The crosslinker may be selected from the group consisting of tetrakis(dimethylsiloxy)silane, methyltris(dimethylsiloxy)silane, phenyltris(dimethylsiloxy)silane and combinations thereof.

In the silicone gel composition, the mole fraction hydride present as crosslinker (MFHC) may be from about 0.2 to about 0.5, or from about 0.3 to about 0.4. In the silicone gel composition, the hydride to vinyl ratio may be between about 0.8 and 1.0.

The chain extender may have two Si—H hydride moieties per molecule. The chain extender may be a hydride containing polydimethylsiloxane, hydride terminated polydimethylsiloxane, hydride terminated polyphenylmethylsiloxane, hydride terminated polydiphenylsiloxane, a functionalized hydride terminated silicone, and combinations thereof.

When both crosslinker and chain extender are employed, the crosslinker may have three or four Si—H hydride moieties, and the chain extender may have two Si—H hydride moieties per molecule

The catalyst may be selected from the group consisting of platinum complexed with divinyltetramethyldisiloxane, cobalt carbonyl complex, and rhodium chloride complex.

### Polyurethane Elastomer Gels

Polyurethane gel blocks having a lubricious surface are provided for use in sealing closure or interconnect systems.

Polyurethane elastomer gels may be formed by reacting a di- or tr-isocyanate with a polyol in the presence of a catalyst, or upon exposure to ultraviolet light. Polyurethanes contain repeated urethane (also known as carbamate) linkages, which may be formed, for example, as illustrated in Scheme (IX).

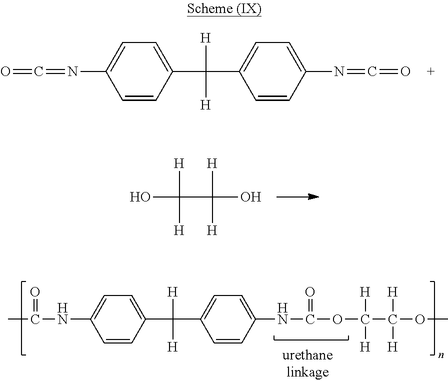

Scheme IX shows a representative reaction of 4,4′-methylenediphenyl diisocyanate with a diol to form a polyurethane. A urethane linkage is shown over bracket.

Isocyanates used to make polyurethane elastomer gels have two or more isocyanate moieties on each molecule. Commonly used isocyanates include aromatic diisocyanates, toluene diisocyanate (TDI) and methylene diphenyl diisocyanates (MDIs) such as 4,4′-MDI, 2,4′-MDI, or 2,2′-MDI. The aromatic diisocyanates are typically more reactive than aliphatic diisocyanates. Aliphatic and cycloaliphatic diisocyanates include, 1,6-hexamethylenen diisocyanate, 1-isocyanato-3-isocyanatomethyl-3,5,5-trimethyl-cyclohexane (isophorane diisocyanate, IPDA) and 4,4′-diisocyanato dicyclohexylmethane (H₁₂MDI or hydrogenated MDI).

The polyols used to make polyurethane elastomer gels have on average two or more hydroxyl moieties per molecule. Polyether polyols can be prepared by polymerizing propylene oxide and/or ethylene oxide with a suitable polyol precursor. Poly(tetramethylene ether)glycols may be prepared by polymerizing tetrahydrofuran. The polyol may be a polyether polyol. The polyol may be prepared, for example, from propylene oxide converted to polyether polyols by alkoxylation. Polyester polyols are prepared by polycondensation of multifunctional carboxylic acids and polyhydroxyl compounds. Higher molecular weights (e.g., 2,000 to 10,000) may be used to make more flexible polyurethanes, while lower molecular weight polyols may make more rigid products. Polyols can be derived from vegetable oils including soybean, cotton seed, neem seed, and castor. Renewable sources used to produce polyols may include dimer fatty acids or fatty acids. Some biobased and isocyanate-free polyurethanes employ reaction between polyamines and cyclic carbonates to produce polyhydroxurethanes. Specialty polyols may include polycarbonate polyols, polycaprolactone polyols, polybutadiene polyols, and polysulfide polyols.

Common catalysts may include tertiary amines, such as DABCO (triethylene diamine, 1,4-diazabicyclo[2.2.2]octane), dimethyl cyclohexylamine (DMCHA), or dimethylethanolamine (DMEA), or metallic soaps such as dibutyltin dilaurate.

Chain extenders (f=2) and cross linkers (f>3) such as low molecular weight hydroxyl and amine terminated compounds may be employed to customize morphology of polyurethane elastomers.

Surfactants may be used to modify polyurethane polymers, such as polydimethylsiloxane-polyoxyethylene block copolymers, silicone oils, nonylphenol ethoxylates.

Some polyurethane gels are solid (non-foamed). Some polyurethane gels do not contain plasticizer oils.

Polyurethane elastomer gels may have a high surface tack, so methods of reducing surface tack and providing a lubricious surface are desirable. Polyurethane gels are commercially available, for example, from Technogel Germany GmbH. Several thermoset and thermoplastic polyurethane gels have been described, for example, in U.S. Pat. Nos. 6,858,699; 8,188,208; 9,593,199; 9,718,917; and US20050222290, Bayer Material Science LLC.

### Thermoplastic Elastomer Gels

Thermoplastic elastomer gel blocks having a lubricious surface are provided for use in sealing closure or interconnect systems.

Traditionally, thermoplastic elastomer gels (TPEGs) have been used as sealants in closures and interconnect systems. Traditional TPEGs may be employed for applications requiring a low maximum service temperature of approximately 70° C. TPEGs may include a base polymer such as a styrenic block copolymer and an extender oil. For example, TPEGs may comprise a styrene ethylene/butylene styrene (“SEBS”) triblock copolymer swollen with a mineral oil softener. While the thermoplastic nature of traditional TPE gels allows for easy production, it limits the upper service temperature due to creep and flow as in-field ambient temperatures approach the styrene glass transition. Thermoplastic elastomer gels are described in, for example, U.S. Pat. No. 4,369,284, Chen, WO 88/00603 Raychem Limited, U.S. Pat. No. 4,942,270, Gamarra, U.S. Pat. No. 5,360,350, Koblitz et al., U.S. Pat. No. 5,541,250 Hudson et al., U.S. Pat. No. 9,166,330 Adams; U.S. Pat. No. 10,316,152 Overdulve et al.; and US2022/0135801 Adams.

Thermoplastic gels may be based on mixing a composition comprising a base polymer with an extender oil (e.g., hydrogenated, refined, paraffin oil −70% paraffin, with a fairly high molecular weight). The base polymer may be, for example, a styrenic block copolymer or an olefinic block copolymer.

Thermoplastic gels prepared from a composition comprising triblock copolymers and styrenic diblock copolymers and a hydrocarbon oil are described in, for example, US Pat. No. The styrenic block copolymers are usually based on styrene and a rubber midblock such as, for example, Kraton G1651 (hydrogenated ethylene butylene midblock) or Septon 2006 (ethylene propylene midblock).

As used herein, the term “styrene diblock copolymer” refers to a diblock copolymer having a polystyrene segment and another elastomeric segment. Styrene diblock copolymers are known. Examples of a “styrene diblock copolymer” include poly(styrene-ethylene/propylene), poly(styrene-ethylene/butylene), and combinations thereof. Other examples of a “styrene diblock copolymer” include poly(styrene-butadiene) and poly(styrene-isoprene). The styrene diblock copolymer can have from about 30 wt % to about 40 wt % styrene, for example, from about 31 wt % to about 39 wt % styrene, from about 32 wt % to about 38 wt % styrene, from about 33 wt % to about 37 wt % styrene, from about 34 wt % to about 36 wt % styrene, or from about 34 wt % to about 39 wt % styrene, for example, about 36 wt % styrene or about 37 wt % styrene.

As used herein, the term “styrene triblock copolymer” refers to a triblock copolymer having polystyrene end segments and another elastomeric center segment. Styrene triblock copolymers are known. Examples of a “styrene triblock copolymer” include poly(styrene-butadiene-styrene) (SBS), poly(styrene-ethylene/butylene-styrene) (SEBS), poly(styrene-ethylene/propylene-styrene) (SEPS), poly(styrene-ethylene/ethylene-propylene-styrene) (SEEPS), and combinations thereof. Another example of a “styrene triblock copolymer” is poly(styrene-isoprene-styrene) (SIS). The styrene triblock copolymer can have from about 30 wt % to about 40 wt % styrene, for example, from about 31 wt % to about 39 wt % styrene, from about 32 wt % to about 38 wt % styrene, from about 33 wt % to about 37 wt % styrene, from about 34 wt % to about 36 wt % styrene, from about 30 wt % to about 33 wt % styrene, from about 31 wt % to about 32 wt % styrene, or from about 32 wt % to about 34 wt % styrene. For example, the styrene triblock copolymer can have about about 32 wt % styrene, about 33 wt % styrene, or about 35 wt % styrene.

In some cases, the thermoplastic gel comprises a base polymer that is a styrenic triblock copolymer. The styrenic triblock copolymer may be, for example, a styrene-ethylene/butylene-styrene (“SEBS”), styrene-ethylene/propylene-styrene (“SEPS”) copolymer, or styrene butadiene styrene (“SBS”) block copolymer.

Styrenic triblock copolymers are commercially available. For example, the polystyrene-poly(ethylene-butylene)-polystyrene triblock copolymers available from Kraton Polymers as KRATON G1641, G1650, G1651, G1654, G1657, G1726, G4609, G4610, GRP-6598, RP-6924, MD-6932M, MD-6933, and MD-6939; the polystyrene-poly(ethylene-butylene)-polystyrene triblock copolymer comprising about 60 wt % polystyrene available from Kuraray as SEPTON S8104; the polystyrene-poly(ethylene-ethylene/propylene)-polystyrene triblock copolymers available from Kuraray as SEPTON® S4044, S4055, S4077, and S4099; and the polystyrene-poly(ethylene-propylene)-polystyrene triblock copolymer comprising about 65 wt % polystyrene available from Kuraray as SEPTON® S2104, the polystyrene-poly(ethylene-butylene-styrene)-polystyrene (S-EB/S—S) triblock copolymers available from Kraton Polymers as KRATON RP-6935 and RP-6936, the polystyrene-poly(ethylene-propylene)-polystyrene triblock copolymers available from Kraton Polymers as KRATON G1730; the polystyrene-poly(ethylene-butylene)-polystyrene triblock copolymer comprising 67 wt % polystyrene available from Asahi Kasei Elastomer as TUFTEC H1043; the polystyrene-poly(ethylene-butylene)-polystyrene triblock copolymer comprising 42 weight percent polystyrene available from Asahi Kasei Elastomer as TUFTEC H1051; the polystyrene-poly(butadiene-butylene)-polystyrene triblock copolymers available from Asahi Kasei Elastomer as TUFTEC P1000 and 2000; hydrogenated polystyrene-polybutadiene-poly(styrene-butadiene)-polybutadiene block copolymer available from Asahi Kasei Elastomer as S.O.E.-SS L601.

In some cases, the thermoplastic gel base polymer may further include a styrenic diblock copolymer. Typical diblock copolymers include Kraton G1701H, G1702H, Septon S1001. Typical triblock copolymers include Kraton G1651H, G1652M, G1654H, Septon S8004 and S2006. For example, hydrogenated styrenic block copolymers such as the polystyrene-poly(ethylene-propylene) diblock copolymers available from Kraton Polymers as KRATON G1701 and G1702 may be employed. Mixtures of two or more block copolymers may be used. Illustrative commercially available unhydrogenated block copolymers include the Kraton D series polymers, including KRATON D1101 and D1102, from Kraton Polymers, and the styrene-butadiene radial teleblock copolymers available as, for example, K-RESIN KR01, KR03, KR05, and KR10 sold by Chevron Phillips Chemical Company. In another embodiment, the styrenic block copolymer is a mixture of high melt viscosity SEBS block copolymer and a functionalized SEBS block copolymer.

The thermoplastic gel may be prepared from a composition comprising a styrene triblock copolymer; a styrene diblock copolymer; and an oil extender, for example, wherein the composition comprises greater than 21 wt % up to about 35 wt % of a combination of the styrene triblock copolymer and the styrene diblock copolymer and the thermoplastic gel has an oil bleed out of less than about 28% after 1500 hours at 60° C. and 200 kPa.

The thermoplastic gel hardness may be adjusted by varying the ratio of diblock to triblock and the amount of extender added. Thermoplastic gel formulations may range from 6% rubber to 20% rubber and 80% diblock (of the total rubber amount) to no diblock. The block copolymers can comprise a mixture or blend of a tri-block copolymer and a diblock copolymer, for example, a mixture comprising styrene-ethylene butylene-styrene SEBS (styrenic tri block copolymer) and styrene-ethylene butylene SEB (styrenic diblock copolymer). In certain embodiments, a weight ratio of the styrene triblock copolymer to the styrene diblock copolymer is in a range of from about 1:2 to about 2:1, about 1:1.5 to about 1.5:1, or from about 1:1.2 to about 1.2:1. The oil extender may be a synthetic oil such as a polyalphaolefin (PAO) oil (e.g., polybutene, polydecene, polydodecene, or polytetradecene), a mineral oil, or any combination thereof. The softener oil may have a high molecular weight oil having a molecular weight greater than 250 g/mol. In some examples, the composition may comprises from about 61 wt % to about 75 wt % of the oil extender, or from about 65 wt % to about 70 wt % of the oil extender.

Optionally other additives may be included in the gel material formulations including UV stabilizers, flame retardants, corrosion inhibitors, fungicide, antioxidants, pigment, etc. In some cases, the gel composition comprises an antioxidant or stabilizer such as a hindered phenol (e.g., Irganox™ 1076, commercially available from Ciba-Geigy Corp., Tarrytown, New York), phosphites (e.g., Irgafos™ 168, commercially available from Ciba-Geigy Corp.), metal deactivators (e.g., Irganox™ D1024, commercially available from Ciba-Geigy Corp.). and sulfides (e.g., Cyanox LTDP, commercially available from American Cyanamid Co., Wayne, New Jersey), light stabilizers (e.g., Cyasorb UV-531, commercially available from American Cyanamid Co.), and/or phosphorous containing organic compounds (e.g., Fyrol PCF and Phosflex 390, both commercially available from Akzo Nobel Chemicals Inc. of Dobbs Ferry, New York) and acid scavengers (e.g., DHT-4A, commercially available from Kyowa Chemical Industry Co. Ltd through Mitsui & Co. of Cleveland, Ohio, and hydrotalcite). Optionally other additives may be included in the gel material formulations including UV stabilizers, corrosion inhibitors, fungicide, antioxidants, pigment, etc. The additional additives may include at least one material selected from the group consisting of Dynasylan® SILBOND 40, Diphenylsiloxane-dimethylsiloxane copolymer Gelest PDM 1922, antioxidants such as 2′,3′-bis[3,5-di-tert-butyl-4-hydroxyphenyl]propionyl]]propionohydrazide Songnox 1024, antioxidants such as octadecyl-3-(3,5-di-tertbutyl-4-hydroxyphenyl)propionate Kingnox® 76, hydrotalcite acid scavenger DHT-4A Kisuma, UV light absorbers such as Kingsorb®, pigment, and mixtures thereof. Other suitable additives include colorants, biocides, tackifiers and the like described in “Additives for Plastics, Edition 1” published by D.A.T.A., Inc. and The International Plastics Selector, Inc., San Diego, Calif. The additives may comprise between 0.1 and 25 wt % of the overall composition, between 0.1 and 5 wt % of the overall composition, between 0.1 and 2 wt % of the overall composition, or between 0.1 and 1 wt % of the overall composition.

In some cases, the thermoplastic gel comprises a base polymer that is a olefinic block copolymer, such as those described in U.S. Patent Application No. 2012/0130011, herein incorporated by reference in its entirety. For example, the olefinic block copolymers may be an elastomeric copolymers of polyethylene, sold under the trade name INFUSE by The Dow Chemical Company of Midland, Mich. (e.g., INFUSE 9107). In one embodiment, the olefinic block copolymer is selected from the group consisting of INFUSE OBC 9000, INFUSE OBC 9007, INFUSE OBC 9100, INFUSE OBC 9107, INFUSE OBC 9500, INFUSE OBC 9507, INFUSE OBC 9530, INFUSE OBC 9807, INFUSE OBC 9817, and mixtures thereof.

In other particular examples, the base polymer may be any such configured polymers such as those available from Kraton Polymers (Houston, Texas), including but not limited to: Kraton MD6684, RP6684, FG190, FG1924, RP6670, 1901, 1901X, B 51-4, FG 120LX, FG 1652, FG 19, FG 1900X, FG 1901, FG 1901X, FG 1901X951, FG 1921X, FG 1924, FG 1924X, FG 1961X, G 1901, G 1901X, G 1901X2, G 1921, GRP 6627, KG 1901, M 1923, MB 1000, RP 6509, RP 6510, RP 6543, RP 6562. In other embodiments, the base polymer may be at least one of the following available from Asahi Kasei Elastomer (Tokyo, Japan): Asahi M 1913, M 1943, and M 1953.

The gel may include at least one additive selected from the group consisting of: flame retardants, coloring agents, adhesion promoters, stabilizers, fillers, dispersants, flow improvers, plasticizers, slip agents, toughening agents, and combinations thereof.

The thermoplastic gel may exhibit a hardness in a range of between 15 Shore OOO and 65 Shore OOO; or between about between 30 Shore OOO and about 45 Shore OOO.

The thermoplastic gel may have less than about 25% oil bleed out after 1500 hours when the gel is under compression of 200 kPa at 60° C., or less than about 20% oil bleed out after 1500 hours when the gel is under compression of 200 kPa at 60° C., or has less than about 16% oil bleed out after 1500 hours when the gel is under compression of 120 kPa at 60° C. The thermoplastic gel may exhibit less than 10% oil bleed out after being under compression of 1.2 atm for 60 days at 60° C., or less than 10% oil bleed out after being under compression of 1.2 atm for at least 26 days at 70° C.

### Hybrid Thermoplastic Elastomer Gels

Hybrid thermoplastic elastomer gel blocks having a lubricious surface are provided for use in sealing closure or interconnect systems. Hybrid thermoplastic gels may be employed, for example, to achieve higher service temperatures.

The gel may be a hybrid thermoplastic gel. Hybrid thermoplastic gels are described in, for example, U.S. Pat. No. 9,736,957, Adams et al.; U.S. Pat. No. 10,058,001, Adams et al. A hybrid thermoplastic gel may be prepared from a composition comprising a base polymer having at least one functional group capable of crosslinking; a functionalized extender; and optionally a crosslinker having multiple functional groups that are capable of reacting with the functional groups in the base polymer or the functionalized extender.

The hybrid thermoplastic gel may be prepared by mixing between at least one base polymer, a functionalized extender, and a crosslinker (or coupling agent) together at an elevated temperature (greater than room temperature) for a period of time. The base polymer may comprise at least one functional group configured to chemically crosslink in the presence of an extender or crosslinker.

In certain embodiments, the hybrid thermoplastic gel is prepared from a composition comprising a base polymer having at least one functional group configured to chemically crosslink in the presence of an extender or crosslinker. For example, the base polymer may have functional groups such as acyls, hydroxyls, sulfhydryls, amines, carbxyls, anhydrides, olefins, and carboxylic acids configured to chemically link in the presence of an extender or crosslinker.

In some embodiments, the base polymer is a styrenic block copolymer. In certain embodiments, the styrenic block copolymer is a styrene-ethylene/butylene-styrene (“SEBS”), styrene-ethylene/propylene-styrene (“SEPS”) copolymer or styrene butadiene styrene (SBS). In yet other embodiments, the base polymer is a olefinic block copolymer, such as those described in U.S. Patent Application No. 2012/0130011, which is incorporated by reference herein in its entirety. For example, the olefinic block copolymers may be an elastomeric copolymers of polyethylene, sold under the trade name INFUSE by The Dow Chemical Company of Midland, Mich. (e.g., INFUSE 9107). In one embodiment, the olefinic block copolymer is selected from the group consisting of INFUSE OBC 9000, INFUSE OBC 9007, INFUSE OBC 9100, INFUSE OBC 9107, INFUSE OBC 9500, INFUSE OBC 9507, INFUSE OBC 9530, INFUSE OBC 9807, INFUSE OBC 9817, and mixtures thereof.

In other particular examples, the base polymer may be any such configured polymers such as those available from Kraton Polymers (Houston, Texas), including but not limited to: Kraton MD6684, RP6684, FG190, FG1924, RP6670, 1901, 1901X, B 51-4, FG 120LX, FG 1652, FG 19, FG 1900X, FG 1901, FG 1901X, FG 1901X951, FG 1921X, FG 1924, FG 1924X, FG 1961X, G 1901, G 1901X, G 1901X2, G 1921, GRP 6627, KG 1901, M 1923, MB 1000, RP 6509, RP 6510, RP 6543, RP 6562. In other embodiments, the base polymer may be at least one of the following available from Asahi Kasei Elastomer (Tokyo, Japan): Asahi M 1913, M 1943, and M 1953.

In other embodiments, the base polymer may further include at least one of the following commercially available copolymers, including hydrogenated styrenic block copolymers such as the polystyrene-poly(ethylene-propylene) diblock copolymers available from Kraton Polymers as KRATON G1701 and G1702; the polystyrene-poly(ethylene-butylene)-polystyrene triblock copolymers available from Kraton Polymers as KRATON G1641, G1650, G1651, G1654, G1657, G1726, G4609, G4610, GRP-6598, RP-6924, MD-6932M, MD-6933, and MD-6939; the polystyrene-poly(ethylene-butylene-styrene)-polystyrene (S-EB/S—S) triblock copolymers available from Kraton Polymers as KRATON RP-6935 and RP-6936, the polystyrene-poly(ethylene-propylene)-polystyrene triblock copolymers available from Kraton Polymers as KRATON G1730; the polystyrene-poly(ethylene-butylene)-polystyrene triblock copolymer comprising 67 wt % polystyrene available from Asahi Kasei Elastomer as TUFTEC H1043; the polystyrene-poly(ethylene-butylene)-polystyrene triblock copolymer comprising 42 weight percent polystyrene available from Asahi Kasei Elastomer as TUFTEC H1051; the polystyrene-poly(butadiene-butylene)-polystyrene triblock copolymers available from Asahi Kasei Elastomer as TUFTEC P1000 and 2000; the polystyrene-polybutadiene-poly(styrene-butadiene)-polybutadiene block copolymer available from Asahi Kasei Elastomer as S.O.E.-SS L601; the polystyrene-poly(ethylene-butylene)-polystyrene triblock copolymer comprising about 60 wt % polystyrene available from Kuraray as SEPTON 58104; the polystyrene-poly(ethylene-ethylene/propylene)-polystyrene triblock copolymers available from Kuraray as SEPTON® 54044, 54055, 54077, and 54099; and the polystyrene-poly(ethylene-propylene)-polystyrene triblock copolymer comprising about 65 wt % polystyrene available from Kuraray as SEPTON® 52104. Mixtures of two or more block copolymers may be used. Illustrative commercially available unhydrogenated block copolymers include the Kraton D series polymers, including KRATON D1101 and D1102, from Kraton Polymers, and the styrene-butadiene radial teleblock copolymers available as, for example, K-RESIN KRO1, KR03, KR05, and KR10 sold by Chevron Phillips Chemical Company. In another embodiment, the styrenic block copolymer is a mixture of high melt viscosity SEBS block copolymer and a functionalized SEBS block copolymer.

In another embodiment, the base polymer comprises maleic anhydride grafted to the block copolymer. The maleated functional groups are examples of functional groups configured for crosslinking during gel processing. These maleated base polymers are particularly configured for crosslinking with extenders, di- and multi-amine crosslinkers, di- and multi-functional epoxies, di- and multi-functional hydroxyl molecules (alcohols and polyols) as well as aluminum, titanium and other organometallic compounds. In some embodiments, the maleated base polymer includes at least one functional group configured to chemically crosslink with a di- and multi-amine crosslinker.

For further example, the maleated functional groups of a maleic anhydride-modified SEBS or SEPS are configured for crosslinking. The chemical crosslinking of the SEBS or SEPS triblocks at the ethylene-butylene or ethylene-propylene blocks may further strengthen the gel structure. The chemical crosslinking produced is capable of raising its softening temperature.

Methods of preparing maleated block copolymers are known in the art and many such block copolymers are commercially available. For example, maleated block copolymers are disclosed in EP 0879832A1. Illustrative commercially available maleic anhydride-modified SEBS are available from Kraton Polymers (Houston, Texas) as KRATON FG1901 (SEBS polymer having a polystyrene content of about 30 wt % and maleic anhydride grafted content of about 1.4-2.0 wt %) and KRATON FG 1924 G (SEBS polymer with about 13 wt % polystyrene and maleic anhydride grafted content of about 0.7-1.3 wt %), and KRATON MD 6684 CS (SEBS polymer having a polystyrene content of about 30 wt % and maleation level of about 1.0 wt %), and KRATON MD 6670. Illustrative commercially available maleic anhydride-modified SEBS are available from Asahi Chemical Industry Co., Ltd. (Tokyo, Japan) under the trade name M-1911 (maleation level of about 3.0 wt %), M-1913 (maleation level of about 2.0 wt %), and M-1943.

In one embodiment, the maleic anhydride modified SEBS is KRATON MD6684CS. In another embodiment, the maleic anhydride-modified SEBS is KRATON FG6684. In yet another embodiment, the maleic anhydride modified SEBS is selected from the group consisting of as KRATON FG1901, KRATON FG 1924 G, KRATON MD 6684 CS, and KRATON MD 6670. In another embodiment, the maleic anhydride-modified SEBS has a maleation level of between 1.0 wt % and 3.0 wt %.

The hybrid thermoplastic gel is prepared from a composition comprising a functionalized extender that is capable of forming a connection with the base polymer and “extend” the length of the base polymer. In certain embodiments, the functionalized extender comprises at least one functional group that is compatible and willing to react with a functional group in the base polymer or the crosslinker/coupling agent. As used herein, the term “functionalized extender” may refer to any compound having a functional group that is compatible and willing to react with a functional group in the base polymer or the crosslinker/coupling agent. In certain embodiments, the term refers to any compound comprising a single functional site that is capable of forming a connection to a base polymer or a crosslinker/coupling agent. In certain embodiments, the functionalized extender is a maleated extender, such as maleated polyisobutylene.

In some embodiments, the functionalized extender is selected from the group consisting of: polyisobutylene, unsaturated hydrocarbon oils, unsaturated paraffins, alkenes or olefins, unsaturated naturals oils such as castor, linseed, soybean, peanut, esters or phthalate esters, polybutadiene, polyisoprene, poly(butadiene/styrene) copolymers, other liquid rubbers, and mixtures thereof. In one embodiment, the functionalized extender is polyisobutylene.

In certain embodiments, the functionalized extender is a maleated extender, such as maleated polyisobutylene or maleated polybutadiene. In one particular embodiment, the functionalized extender is maleated polyisobutylene. In some embodiments, the extender compound is reacted with maleic anhydride to form a maleated extender. In one particular example, about 45 g of maleic anhydride is added to about 500 g of heated polyisobutylene (TPC 595 from Texas Petrochemicals, Houston, Texas), wherein the reaction is carried out at 190° C. for 6 hours. The hot maleated polyisobutylene is then filtered through a 200 mesh filter to remove any charred particles, and then put in sealed glass containers under dry nitrogen. The resulting composition was approximately 80% maleated as determined by the stoichiometry of the ingredients and average molecular weight of the polyisobutylene. Other functionalized extenders (including other polyisobutylene compositions such as Indopol® H100 polyisobutylene, INEOS Oligomers, League City, Texas, or Glissopal 1300 from BASF) may also maleated using a similar procedure.

For example, the hybrid thermoplastic gel may prepared by mixing between 5-40 wt % base polymer, 60-95 wt % functional extender, and 0-10 wt % crosslinker (or coupling agent). The temperature and time at temperature may be adjusted accordingly to target the end properties desired in the gel. For example, the mixing and reacting may be conducted at an elevated temperature between 100-250° C., 150-220° C., or 180-200° C. In some cases, the mixing at the elevated temperature is held for 1-12 hours, 2-8 hours, or 3-6 hours.

In some cases, no catalyst or initiator is needed other than heat to react the base polymer, functionalized extender, and/or crosslinker together to form the hybrid thermoplastic gel. For example, certain ionic crosslinkers may only need heat and time to react and form the gel.

In some cases, an additive or additives may also be added to the gel composition. In certain embodiments, the additive may comprise between 0.1-30 wt % of the overall composition, 1-25 wt % of the overall gel composition, or 5-20 wt % of the overall composition. In particular, the gel may include an additive such as a stabilizer comprising between 0.1-5 wt %, 0.5-3 wt %, or 1-2 wt % of the overall gel composition.

### Crosslinkers

The hybrid thermoplastic gel may be prepared from a composition comprising a crosslinker or coupling agent that is capable of forming connections between the base polymer chains, between the base polymer and functionalized extender, or between functionalized extenders. In certain embodiments, the crosslinker comprises multiple (2 or more) functional groups that are compatible and willing to react with the functional groups in the base polymer or functionalized extender. In certain embodiments, the crosslinker comprises between three and ten functional groups that are capable of forming a connection point between three and ten base polymers or functionalized extenders, such that the crosslinker functions as a branching agent. In another embodiment, the crosslinker comprises four functional groups that are capable of forming a connection point between four different base polymers or functionalized extenders.

Any crosslinker capable of reacting with the functionalized base polymer regions can be utilized, such as covalent bond crosslinking (covalent crosslinkers) or ionic bond crosslinking (ionic crosslinkers).

The crosslinker may be an ionic crosslinker, which may allow for improved re-melting or re-processing the gel by breaking or disassociating the bond at an elevated temperature. In some embodiments, the ionic crosslinker is a metal salt. Organic metal salts may aid in coupling the (maleated) extender to the base polymer molecules. In certain embodiments, the metal salt is a lithium, sodium, calcium, aluminum, or zinc organic metal salts. In one embodiment, the ionic crosslinker is a calcium salt (such as Licomont® CaV 102). The ionic crosslinker may be an aluminum acetylacetonate, iron acetylacetonate, zinc acetylacetonate, titanium acetylacetonate and zirconium acetylacetonate, and mixtures thereof. In one embodiment, the crosslinker is an aluminum salt of acetic acid. For example, the crosslinker may be an aluminum triacetate (Al(C₂H₃O₂)₃), aluminium diacetate, (HO(Al(C₂H₃O₂)₃), or aluminium monoacetate, ((HO)₂(Al(C₂H₃O₂)₃). In another embodiment, the crosslinker is tetra(2-ethylhexyl)titanate.

The crosslinker may be a covalent crosslinker. Chemical crosslinking involves covalent crosslinking (or a covalent crosslinker). Non-limiting examples of covalent crosslinkers include primary, secondary, or tertiary amines, epoxies, hydroxyl-terminated butadienes, polymeric diisocynates, and mixtures thereof.

The thermoplastic gel composition may comprise additional components. For example, the gel composition may include additives such as flame retardants, coloring agents, adhesion promoters, antioxidants, stabilizers, fillers, dispersants, flow improvers, plasticizers, slip agents, toughening agents, and combinations thereof.

### Gel Block Properties

The gel block having a lubricious surface may be used as a sealant in an electrical or telecommunications closure system. In certain embodiments, the closure system comprises a housing, a cable, and a gel block material. In some embodiments, the cable may be a low smoke zero halogen LSZH cable.

Example gel block materials can be defined by properties such as hardness, compression set, resistance to extrusion, elongation to failure, and oil bleed out properties. Example value ranges for each property and testing procedures for measuring these values for sample materials are described below.

### Uses and Properties of the LIS Treated Elastomeric Gel Block

The gel block having at least one surface coated with an LIS additive described herein may be used in a number of end uses due to their improved properties, such as improved behavior in mechanical stresses (e.g., vibration and shock) or ability to seal uneven or complicated structures (due to the ability to flow and adapt to the area of the structure). In certain embodiments, the treated gel blocks may be used in an interconnect, cover, or closure system. In particular, the treated gel blocks may be used as a sealant in a fiber optic closure, electrical sealant, or electrical closure. In some embodiments, the treated gel blocks are used as gel wraps, clamshells, or gel caps. In further embodiments, the treated gel blocks are used in the inside of a residence. In other embodiments, the treated gel blocks are used outside of a residence. Use of the treated gel blocks within a closure or interconnect system may allow for a reduction in the number of components, frame size, or cost over other sealing mechanisms. The treated gel blocks disclosed herein can be used in an enclosure or interconnect system as a sealant on cables entering and exiting the enclosure. The cables can be fiber optic cables, copper cables, or any combination thereof. In embodiments, during such use, the silicone gel is under a sealing pressure from about 20 kPa to about 200 kPa. In other embodiments, during such use, the silicone gel is under a sealing pressure from about 50 kPa to about 150 kPa.

The treated gel blocks exhibits certain desirable measurable properties. For example, in some embodiments, the treated gel blocks exhibit a hardness in the range of 10 to 53 Shore OOO hardness, or 40 to 250 g; or 17 to 42 Shore OOO Hardness, or 50 to 150 g, or 23 to 37 Shore OOO hardness, or 60-120 g, as measured according to methods known in the art. In certain embodiments, the Shore hardness gauge may be measured according to IS0868 or ASTM D2240, or by a Texture Analyzer, as described herein.

In certain embodiments, hardness of the gel blocks can be measured on a texture analyzer. For example, a LFRA Texture Analyzer-Brookfield may include a probe assembly fixed to a motor driven, bi-directional load cell. In such a system, the probe is driven vertically into the sample at a pre-set speed and to a pre-set depth. For example, a probe comprising a stainless steel ball having diameter of 6.35 mm, and a probe speed of 2 mm/sec may be used with a target depth of 4 mm, and a hold time of 60 seconds. The trigger point may be 4 grams. The hardness is the amount of force needed to push the probe into the test sample. The H₆₀ₛ, 60 second hardness value, or 60 second peak load hardness, should not exceed 250 g. The preferred H₆₀ₛ hardness range is less than 200 g and most preferred is less than about 120 g. Similarly, to obtain acceptable mechanical properties and the ability of the closure to be opened and resealed, a minimum 60s hardness of about 40 g is required. The gels of the disclosure may exhibit H₆₀ₛ hardness in the range of 40 to 250 g, 50 to 150 g, or about 60 to about 120 g. In some embodiments, the final load hardness may be from 40 to 250 g, 50 to 150 g, or from about 60 to about 120 g. In some embodiments, the treated gel blocks may have a hardness in the range of 17 to 42 Shore OOO, or 50 to 150 g. In yet other embodiments, the silicone gel has a hardness in the range of 23 to 37 Shore OOO, 18 to 33 Shore OOO, or 60 to 120 g.

The hardness can also be measured on a texture analyzer, as described above. For example, a LFRA Texture Analyzer-Brookfield may include a probe assembly fixed to a motor driven, bi-directional load cell. In such a system, the probe is driven vertically into the sample at a pre-set speed and to a pre-set depth. The hardness is the amount of force needed to push the probe into the test sample. For the gel block material of the disclosure, the characteristic hardness of interest may be the force measured 60 seconds after the 6.35 mm spherical probe is pushed into the gel to a depth of 4.0 mm. The H₆₀ₛ, 60 second hardness value, should not exceed 250 g. The preferred H₆₀ₛ hardness range is less than 200 g and most preferred is less than about 120 g. Similarly, to obtain acceptable mechanical properties and the ability of the closure to be opened and resealed, a minimum 60s hardness of about 40 g is required. The gel block material of the disclosure may exhibit H₆₀ₛ hardness in the range of 40 to 250 g, 45 to 200 g, 50to 150 g, 70 to 130 g, or 60 g to 120 g.

### Indentation Hardness

The gel block material can be tested for indentation hardness using a texture analyzer including a load cell and a probe assembly. The load cell may be motor drive. The load cell may be bi-directional. The probe assembly includes a stainless-steel ball probe. The ball probe has a size of about 6.35 mm (0.25 in). The load cell has a minimum resolution of 0.20 g and +0.5% FSR accuracy. The load cell has a trigger point of about 4 g (grams force). One example texture analyzer suitable for the hardness test is the Brookfield CT3 Model 1500 offered by Brookfield Engineering Laboratories, Inc. of Middleboro, MA.

During the test, the material to be tested is placed in a cup beneath the probe assembly. The cup is formed from aluminum. The cup is filled with 51 grams of the material to be tested. The material filling the cup is bubble free. The cup has a frusto-conical inner shape having a major inner diameter of 50 millimeters at an open top end, a minor inner diameter of 45 millimeters at a closed bottom end, and a depth of 30 millimeters extending between the top and bottom ends.

The load cell drives the probe assembly vertically into a sample of material at a speed of 2 mm/sec to a depth of 4 mm. The load cell holds the probe assembly at the 4 mm depth for 1 hour.

The indentation hardness is measured (in grams) as a peak force and a residual force applied by the load cell to the probe assembly. The peak hardness is measured instantly when the probe assembly is at the pre-set depth from the trigger point. The residual hardness is measured at the pre-set depth after passage of the pre-set period of time. For example, the residual hardness may be measured after 1 hour (3600 seconds). In certain examples, an average and standard deviation are calculated for the peak force and residual force measurements. In one example, a gel block material suitable for use in the gel sealing applications described herein have a residual indentation hardness ranging from 40 g (grams force) to 250 g, 50 g to 150 g, or 60 g to 120 g after 1 hour.

The LIS treated gel block may exhibit certain desirable tack properties such as tackiness, adhesive force, adhesion (adhesiveness), and/or tack time. The tack properties may be measured may be measured using a Texture Analyzer, for example, a Brookfield RAY-K-00184. For example, the texture analyzer may be fitted with a cylindrical aluminum probe with a diameter of 20 mm, with a trigger load of 4 g, a probe speed of 2.0 mm/sec and a hold time of 15 sec. Adhesion (adhesiveness) is the area under the force vs. distance curve for all negative values of load detected at the end of the test as the probe returns to the home position, reported in mJ. Adhesive force is the peak negative value, for example, reported in g. Adhesive force (N), or negative adhesive force to remove probe from the gel (g), adhesiveness (mJ), and tack time (s) may be measured. Adhesiveness is a measure of stickiness and is calculated as the area under the negative peak as probe withdraws after the first compression.

In some embodiments for the LIS treated gel block, the adhesiveness may be from 0.2 to 2.5 mJ, or 0.2 to 2 mJ, or no more than 2.5 mJ, no more than 2 mJ, or no more than 1.5 mJ when measured by Texture Analyzer.

Adhesive force is the force required to pull probe from sample (suction).

In some embodiments for the treated silicone gels, the negative adhesive force threshold is no more than 250 g, no more than 200 g, or no more than 150 g, or no more than 120 g, or from 40 g to 250 g, or 50 g to 150 g, or 60 to 120 g when measured by Texture Analyzer.

In some embodiments for the LIS treated gel block, the tack time is no more than 1.2 sec, no more than 1.0 sec, no more than 0.8 seconds, or from 0.2 to 1.2 sec, or 0.3 to 0.8 sec when measured by Texture Analyzer.

For LIS treated gel block, the target negative force threshold can be no more than 300 g, no more than 200 g, or no more than 170 g when measured by Texture Analyzer. In some embodiments, for LIS treated gel block, the target negative force threshold may be no more than about 200 g, or no more than about 150 g when measured by Texture Analyzer within about 1 week of surface treatment. In some embodiments, for silicone dry gels with surface treatments, the target negative force threshold is no more than about 200 g when measured by Texture Analyzer after 3 weeks at ambient room temperature.

### Contact Angle and Sliding Angle Measurement.

Contact angle and sliding angle (roll off angle) measurements can be performed by a contact angle goniometer (VCA-Optima from AST products, Inc.). Milli-Q water (1018 Ω/cm) and organic liquids can be used as probe liquids with a volume of 2 μL during contact angle measurement. For sliding angle measurements, a 5 μL probe liquid droplet is first deposited on the surface. The substrate is tilted at a constant low rate. As soon as the droplet began to slide, the angle at which the substrate is tilted is recorded as the sliding angle of the probe liquid. If the probe water drop does not slide by the time a 150 tilt is achieved, the measurement is stopped and the sliding angle is recorded as 15°, indicating a “nonslippery” surface. Each measurement is repeated 3-5 times at different areas of the surfaces.

### Compression Set

The gel block material can be tested for compression set under constant deflection in air. In certain examples, the material is tested using ASTM D395, Method B. The material to be tested is formed into a cylindrical sample. The cylindrical sample has a diameter of about 20 mm and a height of about 20 mm. The test is conducted using an oven (e.g., air-circulating) and a compression fixture. The compression fixture includes compression plates, spacers, and components to compress the plates. The compression plates are arranged in a vertical orientation so that the compression fixture has top and bottom compression plates. The compression plates and spacers are formed from steel. The plates have the dimensions 150 mm length×150 mm width×12.5 mm height. The spacers have the dimensions 25 mm width×10 mm height. The spacers each have an 8 mm center hole. The components to compress the plates include bolts and nuts. The bolts are 10 mm long.

During the test, the sample (e.g., the cylindrical sample) is placed on the compression fixture between the top and bottom compression plates so that the height of the sample extends along an axis between the top and bottom plates. The nuts and bolts are tightened to move the compression plates together to compress the sample. The spacers are positioned between the compression plates to limit the compression of the sample. In certain examples, the compression plates are moved relatively towards each other (e.g., the top plate is moved towards the bottom plate, the bottom plate is moved towards the top plate, or both plates are moved towards each other) until the compression plates are separated by a height of the spacers. For example, the sample may be compressed to a height of about 10 mm using 10 mm tall steel spacers.

The compressed sample is placed in the oven at a pre-set temperature for a pre-set period of time. In certain examples, the compression fixture and the sample are placed in the oven. The compression fixture holds the sample in the compressed state while in the oven. The compressed sample remains in the oven for 22 hours while the oven maintains an internal temperature of 70° C.

The heated sample and compression fixture are removed from the oven after the pre-set period of time. The top compression plate is removed from the sample to allow the sample to recover. For example, the nuts and bolts may be loosened and/or removed so that the top compression plate can be removed from the sample.

The height of the sample is measured after 100 hours of recovery time. The percent compression set is calculated by the following equation:

$$Compression set = \frac{( OH - PH )}{( OH - SH )} \times 100 \qquad ( 1 )$$

where OH is the original sample height, PH is the sample height after testing and recovering, and SH is the spacer height.

In some examples, the compression set, as measured after 50% strain is applied for 1000 hours at 70° C., may be less than 20%, or may have a range between 4% and 20%. In other embodiments, the compression set, as measured after 50% strain is applied for 1000 hours at 70° C., may have a range between 10% and 14% when measured according to the modified version of ASTM D395, method B. In some examples, a gel block material suitable for use in the gel sealing applications described herein may exhibit a compression set of less than 10% after 20 minutes of recovery time, or less than 10% after 10 minutes of recovery time, or less than 5% after 60 minutes of recovery time, or less than 5% after 30 minutes of recovery time.

### Resistance to Extrusion

The gel block material can be tested for resistance to extrusion using an extrusion fixture, a pneumatic cylinder, and an oven (e.g., an air-circulating oven). The extrusion fixture includes a body defining an interior test chamber and an extrusion plate that selectively covers a first end of the test chamber. The test chamber is cylindrical in shape and as a diameter of 25 millimeters. The extrusion plate closing one end of the test chamber defines a 4 mm circular opening in its center in fluid communication with the test chamber.

The material to be tested is formed into a cylindrical sample having a diameter of 25 mm and a height of 25 mm.

During the test, the sample is placed inside the cylindrical test chamber and the extrusion plate is placed over the first end of the test chamber. An aluminum cup is placed outside the extrusion fixture beneath the circular opening.

A compression plate is placed behind the sample at an opposite second end of the test chamber. The compression plate is round with a diameter of 25 mm. The compression plate is low friction and formed of plastic. A pneumatic cylinder is operationally coupled to the compression plate to move the compression plate relative to the extrusion fixture. In particular, compression rods of the pneumatic cylinder contact the plastic compression plate.

The pneumatic cylinder is energized and pressurized such that the pneumatic cylinder applies 200 kPa of pressure to the sample. The pressurized sample and pneumatic cylinder are placed in the oven at 70° C. Materials that are not extrusion resistant will fall into the aluminum cups. Materials that are extrusion resistant will bulge out of the opening in a bulbous extrusion. If no part of the sample falls into the aluminum cup, then the pressure is removed from the sample after 24 hours. The sample is allowed to recover with no pressure applied and allowed to return to room temperature. Once the sample returns to room temperature, the volume (if any) that remains extruded in a bulge outside the extrusion plate is measured. In certain examples, suitable materials will have a measured volume of no more than 0.5 cm³, or no more than 0.25 cm³ or 0 cm³.

### Elongation to Failure

The gel block material can be tested for tensile elongation using ASTM D638. For example, the material can be tested using a Universal Test Machine (UTM), such as a Universal Testing System offered by Instron of Norwood, MA. The UTM includes a 2 kg load cell and two cylindrical rods. Each cylindrical rod has a 6 mm diameter and is formed of steel. The rods are each horizontally oriented with a lower rod attached to a stationary base of the UTM and an upper rod attached to the load cell. Accordingly, the lower rod remains stationary relative to the base while the upper rod is movable relative to the lower rod using the load cell.

The material to be tested is cut into rings having an outer diameter of 30 mm and an inner diameter of 20 mm. The rings have a thickness of 3-4 mm.

During the test, the rings are positioned so that the upper and lower rods extend into the rings. The load cell is moved at a rate of 50 mm/min. Accordingly, the upper rod moves away from the lower rod at that rate. As the upper rod is moved, the UTM measures a force applied to the upper rod versus the extension curve of the ring. From these measurements, the elongation to failure is calculated. The elongation to failure is calculated based on the initial length (approximately 31.5 mm) of the ring. In certain examples, suitable materials will have an elongation to failure of at least 500%, at least 600%, or at least 800% of the initial length of the sample.

### Oil Bleed Out

The gel block material can be tested for oil bleed out to determine the oil loss of the material under pressure. The material to be tested is formed into multiple cylindrical samples each having a diameter of 14 mm and a thickness of 3-4 mm.

The test is performed using a test block, three coarse screens (0.16 mm² mesh), three fine screens (0.01 mm² mesh), three pistons, three weights, an analytical balance, and an oven. The test block defines three testing cavities having open upper ends. Each testing cavity is sized to receive one of the cylindrical samples through the open upper end. The weights are shaped to fit partially into respective testing cavities through the open upper ends.

During the test, the initial weight of each sample is measured. Each sample is placed on a respective fine screen. Then, each sample and corresponding fine screen is placed on a respective coarse screen. The screens support the samples while allowing low molecular weight material to separate. Each sample and corresponding screens is placed within one of the cavities defined in the test block.

A respective piston is placed over each sample within the respective testing cavity. A respective weight is placed over each piston to apply 120 kPa of pressure to the respective sample. The weight is shaped so that a portion of the weight extends downwardly into the testing cavity through the open upper end. The test block, screens, samples, pistons, and weights form a testing assembly. The testing assembly is placed in an air circulating oven at a temperature of 70 Celsius.

At regular intervals, the testing assembly is removed from the oven and the samples are removed from the testing block. The samples are blotted on cleaning paper and weighed on an analytical balance. After weighing, the samples are replaced within the respective testing cavities and the weights are replaced over the samples. The testing assembly is returned to the oven. These regular intervals are repeated until at least 500 hours have elapsed or the sample weights have stabilized. In certain examples, the sample weight of suitable materials measured at 500 hours will be greater than or equal to 80% of the initial weight (e.g., less than 20% oil bleed out), or greater than or equal to 85% of the initial weight (e.g., less than 15% oil bleed out), or greater than or equal to 90% of the initial weight (e.g., less than 10% oil bleed out). The oil bleed out may be less than 20%, less than 15%, or less than 10% oil bleed out after being under compression of 1.2 atm for 60 days at 60° C.

In some embodiments, the gel block material may be used in a closure or interconnect system that is “compatible” with cable, for example, a low smoke zero halogen (LSZH) cable. In certain embodiments, compatibility is measured by subjecting the sample to one or more mechanical or environmental tests to test for certain functional requirements. In some embodiments, compatibility is measured by passing a pressure loss test, tightness test, and/or visual appearance test. In certain embodiments, the gel in the closure or interconnect system is compatible.

Tightness may be tested under International Electrotechnical Commission (IEC) Test 61300-2-38, Method A and IEC 60068-2-17, Test Qc. In certain embodiments, tightness is tested by immersing the specimen in a water bath and using an internal pressure of 20-40 kPa (0.2-0.4 atm) for 15 minutes. It is important that tightness is measured directly after installing the closure at a temperature of −15° C. or 45° C. It is also important that all the air bubbles present on the outside of the closure are removed. If a continuous stream of air bubbles is observed, this means the specimen is not properly sealed and it will be considered as a failure (i.e., not compatible).

Pressure loss may be tested under IEC 61300-2-38, Method B. In certain embodiments, the gel and cable are compatible if the difference in pressure before and after the test is less than 2 kPa (0.02 atm).

Visual appearance may be tested under IEC 61330-3-1 by examination of the product with the naked eye for defects that could adversely affect the product performance.

The sample may be subjected to various mechanical and/or environmental conditions prior to testing tightness, pressure loss, visual appearance, etc. In certain embodiments, compatibility is determined by subjecting the sample to one or more of the following mechanical tests: axial tension test, flexure test, re-entry test, and torsion test, and/or one or more environmental tests: resistance to aggressive media test, resistance to stress cracking test, salt fog test, temperature cycling test, and waterhead test.

The sample may be subjected to an axial tension test according to IEC 61300-2-4. In this test, the sample may be pressured internally at 20 kPa (0.2 atm) or 40 kPa (0.4 atm) at room temperature and sealed. The base assembly is clamped and a force is applied to each of the extending cables individually. If the sample has an outer diameter of less than or equal to 7 mm, then the amount of force per cable applied is equal to (outer diameter/45 mm)*500 Newtons (“N”). This force is applied for 15 minutes for each cable and built up to the IEC 61300-2-4 test. If the sample has an outer diameter of greater than 7 mm, then the amount of force per cable applied is equal to (outer diameter/45 mm)*1000 N, with a maximum of 1000 N applied. This force is applied for one hour. Internal pressure is then examined for pressure loss. In certain embodiments, the gel and cable are compatible if the pressure loss is less than 2 kPa (0.02 atm). In addition, in certain embodiments, the gel and cable are compatible if the displacement of the cable is less than 3 mm. In other embodiments, the specimens are further subjected to the tightness test, previously described.

The compatibility of the sample may be measured by subjecting the sample to a flexure test according to IEC 61300-2-37. In this test, the samples are subjected to temperatures of −15° C. and 45° C. Samples are pressured internally at 20 kPa or 40 kPa (0.2 atm or 0.4 atm) and sealed. Cables are bent individually at an angle of 30 degree (or a maximum force application of 500 N) each side of neutral in the same plane. Each bending operation is held for 5 minutes. The cable is returned to its original position and then the procedure is repeated in the opposite direction. After 5 cycles on each cable, the samples are visually inspected by the naked eye for appearance, conditioned at room temperature, and subjected to a tightness test. In some embodiments, the gel and LSZH cable are compatible if the specimen passes the visual appearance test, pressure loss test (i.e., less than 2 kPa (0.02 atm)), and/or tightness test.

The compatibility of the sample may be measured by subjecting the sample to a re-entry test according to IEC 61300-2-33. In certain embodiments, re-entry can be simulated after a certain time of temperature cycling. To complete this test, the closure has to be removed from the cycling room and tested on tightness. After this a reentry test can be done. In this test, a dummy plug or cable is removed from the closure and another cable or dummy plug is added. Then, tightness is measured again. Re-entry is successful if the closure passes the tightness test again.

Another mechanical test may be employed to determine compatibility. The sample may be subjected to a torsion test according to IEC 61300-2-5. After completion of the torsion test, the gel and cable may be considered compatible if the sample passes the visual inspection test, pressure loss test, and/or tightness test.

In yet other embodiments, compatibility is measured by conducting an environmental test of temperature cycling or accelerated aging under IEC 61300-2-22 and IEC 60068-2-14, Test Nb. In one embodiment, the temperature cycling test is conducted on the cable jacket between the gel blocks by cycling the temperature between −40° C. and 70° C. for 10 days at two cycles between the extreme temperatures per day. In some embodiments, the humidity is uncontrolled, the dwell time is four hours and the transition time is two hours. In certain embodiments, the cable jacket is tested for maintenance of tensile strength, ultimate elongation, tightness, visual appearance, and/or re-entry. Also, in certain embodiments, after the temperature cycling test, tightness of the closures needs to be tested after being conditioned to room temperature for a minimum of 2 hours. Therefore, in certain embodiments, the gel and cable, e.g., LSZH cable are compatible if the specimen passes the tightness test.

In another embodiment, compatibility is determined by subjecting the sample to a resistance to aggressive media test under EEC 61300-2-34, ISO 1998/I, and EN 590. The sample is considered compatible if it subsequently passes the tightness and/or appearance test.

In yet another embodiment, compatibility is determined by subjecting the sample to a resistance to stress cracking test under IEC 61300-2-34. The sample is considered compatible if it subsequently passes the tightness test and/or shows no visible signs of cracking.

In other embodiments, compatibility is determined by subjecting the sample to a salt fog test under IEC 61300-2-36 and IEC 60068-2-11, Test Ka. The sample is considered compatible if it subsequently passes the tightness and/or appearance test.

In some embodiments, compatibility is determined by subjecting the sample to a waterhead test under IEC 61300-2-23, Method 2. The sample is considered compatible if there is no water ingress.

One challenge in formulating a gel that behaves as described lies in crosslinking the gel such that it has good mechanical properties (strength and relatively high elongation) but is not too hard to close the opening around the round cross section of the cable without excessive force required to shut the closure. This gel property is characterized by the hardness. For example, in some embodiments, the gel block material may exhibit a hardness as described herein above, or in the range of 10 to 53 Shore OOO hardness; 17 to 42 Shore OOO; or 23 to 37 Shore OOO Hardness, or 40 to 250 g, 55 to 200 g, 50 to 150 g, or 60 to 120 g hardness as measured using a texture analyzer, or other methods known in the art. In some embodiments, the gel block material may exhibit a hardness as described herein above, or in the range of 10 to 53 Shore OOO Hardness, or 40 to 250 g, as measured according to methods known in the art. In some embodiments, the gel block material has a hardness in the range of 17 to 42 Shore OOO, or 50 to 150 g. In other embodiments, the gel block material has hardness in the range of 23 to 37 Shore OOO, or 60 to 120 g. In certain embodiments, the Shore hardness gauge is measured according to IS0868 or ASTM D2240.

In some embodiments, the gel is compressed with a certain strain or deformation (e.g., in certain embodiments, to 50% of its original size). This causes a certain stress in the material. The stress is now reduced because the material relaxes. In certain embodiments, the stress relaxation of the gel block material has a possible range between 30 and 60% when subjected to a tensile strain or deformation of about 50% of the gel's original size, wherein the stress relaxation is measured after a one minute hold time at 50% strain. In other embodiments, the stress relaxation of the gel block material is between 40% and 60% when subjected to a tensile strain of about 50%. A higher stress relaxation indicates that once a gel is installed in a closure, the gel will require less stress in order for it to seal.

### Liquid Infused Surface Treatments (LIS).

Elastomeric gel blocks having a lubricious surface are provided for use in sealing closures or interconnect systems. Closures and interconnect systems having gel block seals with liquid infused surfaces exhibit reduced force to re-open closures and interconnect systems, reduced surface tack, reduced adhesiveness, and self-cleaning properties.

The elastomeric gel blocks can be silicone gel blocks, polyurethane gel blocks, thermoplastic gel blocks, or hybrid thermoplastic gel blocks. The silicone gel blocks may be silicone dry gels or silicone oil gels.

Liquid infused surfaces (LIS) comprise a surface of a gel block according to the disclosure having a textured or smooth surface and a liquid layer. The LIS provides a slippery surface to substantially reduce friction between the LIS and, for example, a solid surface, such as found in telecommunications closures or interlock systems. LIS coatings are comprised of a solid or porous solid layer with appropriate surface chemistry and a subsequent liquid (or lubricant) layer that spreads throughout the solid texture and is stabilized by capillary forces. The contact liquid (i.e., water droplet or product) slides on the liquid layer because the liquid layer effectively eliminates the non-slip boundary condition.

LIS is a technology that uses dynamic and thermodynamic frameworks, which aid in the design of stable, slippery coatings for specific applications. While traditional coatings create a dry solid surface, LIS coatings are comprised of solid and liquid materials that are formulated to provide a long-lasting wet and slippery surface. For example, a textured surface may be coated with a textured solid. A liquid layer is applied and spontaneously wicks into the textured (or porous) solid and lasts for the duration of the product lifetime. While paint coatings must coalesce and dry into a thin film, LIS coatings become functional as soon as the liquid is applied.

In some examples, when formulating an LIS coating an appropriate combination of solid and liquid materials must be identified, and a viable method for application of the underlying textured solid must be identified. Typical texture fabrication techniques may include photolithography, wet etching, sol-gel synthesis, and layer-by-layer.

LIS coatings are described in U.S. Pat. Nos. 8,574,704; 10,421,866; and 10,870,505. U.S. Pat. No. 10,421,866 describes durable lubricious surfaces (DLS) including liquid infused surfaces (LIS) and enhanced liquid infused surfaces (ELIS) comprising impregnating liquids that are impregnated in a surface that includes a matrix of solid features defining interstitials regions, such that the interstitial regions include the impregnating liquid. The impregnating liquid is configured to wet the solid surface preferentially and adhere to the micro-textured surface with strong capillary forces, such that the LIS has a roll off angle or sliding angle less than that of the native surface or substrate (e.g., a roll off angle of less than about 5 degrees). This enables the contact liquid to slide with substantial ease on the DLS or enhanced liquid infused surface.

Zhang et al. describe surface functionalization for a non-textured liquid-infused surface with enhanced lifetime by enhancing the lubricant to remain on the surface even during washing. A layer of polydimethylsiloxane (PDMS) is grafted to the surface which stabilizes a layer of silicone oil. The effectiveness of layer was studied as a function of PDMS molecular weight. The LIS showed enhanced longevity. Zhang et al., ACS Appl Mater Interfaces 2018 Feb. 14; 10(6):5892-5901.

LIS surfaces may be enhanced using interfacial modifiers as provided in U.S. Pat. No. 10,421,866, Renner et al., (LiquiGlide Inc., Cambridge MA) describing systems and methods for creating durable lubricious surfaces (DLS) via interfacial modification. The DLS can be prepared via a combination of a solid, a liquid, and an additive that modifies the interface between the DLS and a contact liquid. Renner describes use of durable lubricious surfaces (DLS) on a substrate such as the inner surface of a container or vessel (e.g., plastic, glass, metal) that is enhanced to improve durability with a contact liquid (e.g., product), for example, certain classes of contacting Bingham plastics or other liquids that exhibit a yield stress (“yield stress liquids”), such as toothpaste, ketchup, or mayonnaise. A “durable lubricious surface” (DLS) is a class of engineered surfaces with increased lubricity, wherein “liquid infused surfaces” (LISs), and “enhanced liquid infused surfaces” (ELISs) are a non-exhaustive list of specific embodiments that can be included within the durable lubricious surface class of surfaces. The DLS can be prepared via a combination of a solid, a liquid, and an additive that modifies the interface between the DLS and a contact liquid, resulting in an interfacial layer that acts as a lubricant and/or protective coating between the DLS and the contact liquid. The lubricating effect created between the additive and the contact liquid results in enhanced slipperiness, as well as the protective properties that can help with durability of the DLS.

The present disclosure provides a method of preparing an LIS treated elastomeric gel block comprising obtaining an elastomeric gel block substrate; combining a solid, a liquid, and optionally an additive; and disposing the mixture on at least one surface of the gel block substrate to form a liquid infused surface (LIS) or enhanced liquid infused surface (ELIS).

The gel block substrate 110 may be pre-treated to texturize or roughen the one or more surfaces, for example, by mechanical techniques such as laser cutting, engraving, scoring, wet etching, photolithography, sol-gel synthesis, 3D printing, layer-by-layer deposition, particle deposition, or chemical treatment or functionalization. In some embodiments, the gel block substrate 110 can include one or more surfaces with inherent roughness (complexity equal to or greater than 10%) that results in better performance with the addition of the LIS.

In some embodiments, the surface treatment of the gel block substrate 110 can be a chemical treatment or functionalization. For example, the gel block surface may be pre-treated by functionalizing with a silane, such as 1,3,5,7-tetramethylcyclotetrasiloxane, followed by a layer of divinyl-terminated PDMS (e.g., Mw 6,000 Gelest, Inc.) with the help of hydrosilation reaction with a catalyst, e.g., Karstedt's catalyst (Pt catalyst, platinum(0)-1,3-divinyl-1,1,3,3-tetramethyldisiloxane complex). Although both ends of PDMS could theoretically attach to surface, entropic forces may lead to on average only one end of PDMS may attach to surface, especially at lower molecular weights, giving the treated gel block a brush-like layer. An impregnating liquid 160 such as a layer of silicone oil may be spin coated to treated gel block substrate. See Zhang et al., ACS Appl. Mater. Interfaces 2018, 10, 5892-5901.

The liquid may have an average thickness on the substrate, and the average dimension of the first plurality of particles may be less than about 1.5 times the average thickness of the liquid. In some cases, the average thickness of the liquid is between about 5 um and about 80 um, or between about 10 um and 50 um. As used herein, the term “average thickness” is the total liquid volume divided by the total coated surface area.

Some methods include disposing a composition on a gel block substrate to form a lubricious surface, the composition including a liquid, a first plurality of particles, and a second plurality of particles; disposing a contacting phase on the lubricious surface; and allowing at least a portion of the second plurality of particles to migrate to the contacting phase.

In some embodiments, use of an additive or interfacial modifier in formation of the LIS may offers the advantages including: i) cloaking of the contact liquid; ii) prevent degradation of the LIS; iii) the existence of the altered interface (i.e., ‘contacting phase’ or ‘boundary region’) can help prolong slipperiness and enhance durability.

As used herein, unless otherwise specified, the term “substrate” refers to a surface of an elastomeric gel block.

As used herein, the term “contact liquid” refers to water, muddy water, icy water, or some other contaminating environmental liquid that can come into contact and is desirably excluded from the interior of the closure or interconnect system.

As used herein, the term “contact solid” refers to a cable, closure surface, untreated gel block surface, or interconnect surface, that can contact the LIS.

As used herein, the term “roll off angle” or “sliding angle” refers to the inclination angle of a surface at which a drop of a liquid disposed on the surface starts to roll. In some embodiments, the LIS of the present disclosure exhibits a roll off angle of less than about 5 degrees.

As used herein, the term “spray” refers to an atomized spray or mist of a molten solid, a liquid solution, or a solid particle suspension.

As used herein, the term “complexity” is equal to (r−1)×100% where r is the Wenzel roughness, e.g., the ratio of the actual rough real surface and apparent area of the ideal flat surface.

As used herein, the term “average thickness” is the total liquid volume divided by the total coated surface area.

As used herein, the term “lubricity” is the speed of travel of a material across a lubricious surface.

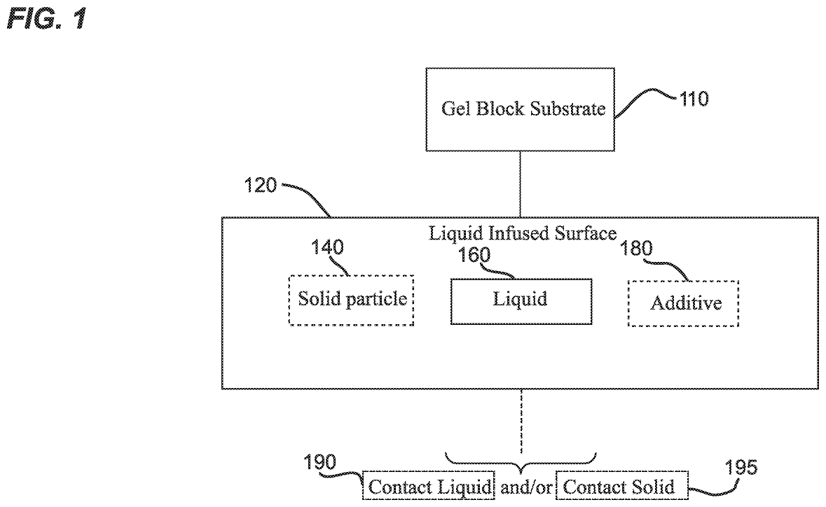

FIG. 1 shows an exemplary schematic illustration of an elastomeric gel block having a lubricious surface. The system includes an elastomeric gel block substrate 110 and an liquid-infused surface (LIS) 120 comprising an impregnating liquid 160, a solid particle 140 and optionally an additive 180. In some embodiments, the impregnating liquid 160 can be immiscible with a contact liquid 190, such as water. Some exemplary impregnating liquids 160 that are immiscible with certain classes of the contact liquid 190 include silicone oils, fluorinated hydrocarbons, fluorinated perfluoropolyethers, and hydrocarbon liquids including mineral oil, paraffin oil, C₁₃-C₁₄ isoparaffins, C₁₆-C₁₈ isoparaffins, diglycerides, and triglycerides. The contact liquid 190 may be water, or other undesirable contaminating environmental fluid. The contact solid may be a cable, untreated elastomeric gel block surface, closure surface, or interconnect surface in an electrical or telecommunications closure or interconnect system.

In some cases, solid particles can be added to the liquid 160 in order to achieve the desired rheology, viscosity, shear strength, any other physical, chemical and mechanical properties, and any combination thereof. The particles can be added to the liquid 160 topping the solid features disposed on the substrate 110 in order to achieve the desired rheology, viscosity, shear strength, any other physical, chemical and mechanical properties, and any combination thereof. The particles can form a particle-laden lubricant on the substrate 110 stabilized against deformation or depletion by interfacial forces enhanced due to the additive 180 or interfacial modifier. In some embodiments, the particle-laden lubricant comprising the liquid and particles is stabilized by the IM additive 180 resulting in greater shear strength, burst strength, compressive strength, tensile strength, impingement resistance, any other mechanical properties, or any combination thereof for at least one of the LIS 120 and the substrate 110.

The solid 140 can include different materials, including surface features already present on the substrate 110. The solid 140 can include one or more members from the following list of hydrocarbon wax, silicones, specifically elastomers, alkyl silicone waxes, polyethylene, polytetrafluoroethylene, polypropylene, amide wax, ethylene-bis(stearamide) wax, Styrenic Block copolymers, including but not limited to, SEP: Polystyrene-b-poly(ethylene/propylene), SEPS: Polystyrene-b-poly(ethylene/propylene)-b-polystyrene, SEBS: Polystyrene-b-poly(ethylene/butylene)-b-polystyrene, SEEPS: Polystyrene-b-poly(ethylene-ethylene/propylene)-b-polystyrene, SIS: Styrene-Isoprene-Styrene; one or more members from the following list of Poly-olefin based thermoplastic elastomers, including but not limited to, Ethylene-Propylene random copolymer (EPM), Hydrogenated polybutadiene-isoprene-butadiene block copolymer, one or more members from the following list of Polyamide based thermoplastic elastomers, including but not limited to, Polyesteramides (PEA), Polyetheresteramides (PEEA), Polycarbonate esteramides (PCEA), Polyether-block-amides (PE-b-A); and one or more members from the following list of Polyacrylate based thermoplastic elastomers, including but not limited to, Poly(MMA-b-tBA-MMA) and Poly(MMA-b-alkyl acrylate-MMA).

The solid 140 can comprise a matrix of solid features formed from one or more of materials from some classes of gel forming materials. Some of the gel forming solids include categories of polymers and copolymers, such as hydrocarbon polymers, star polymers, block copolymers, silicones, specifically elastomers, alkyl silicone waxes, hydrocarbon waxes, polyethylene, polytetrafluoroethylene, polypropylene, amide wax, ethylene-bis(stearamide) wax, polymethylsilsesquioxane, vinyl dimethicone copolymers, gelatin, chitin, chitosan, carboxymethylcellulose, ethyl cellulose, cellulose acetate, cellulose esters. The gel forming solids/materials may include materials which are formed in to gel by the infusion of several classes of liquids. Such materials have the material property of being able to absorb liquids of certain classes and result in self-assembled solid features or structures of the type that are classified under the category of gels. In some embodiments, this is defined as having viscoelastic properties typical of gel materials defined by storage modulus, loss modulus and a phase angle measured in tensile and shear loads. The solid 140 can be a micronized hydrocarbon wax such as a polypropylene wax.

The solid 140 may also comprise some classes of gel forming liquids. When mixed with gel forming solids, the gel forming materials result in gel formation including but not limited to hydrocarbon liquids, such as for example, mineral oil, paraffin oil, C₁₃-C₁₄ isoparaffins, C₁₆-C₁₈ isoparaffins, di- and triglyceride esters, tri alkyl esters of citric acid, glycerol di- and triesters, esters of myristates, adipates, sebacates.

The impregnating liquid 160 can be a solvent liquid. As described herein, some examples of solvent liquids can include hydrocarbon liquids, esters, and ethers. Examples of hydrocarbon liquids include, but are not limited to alkane liquids and mixture of alkanes, C₁₃-C₁₆ isoparaffins, isohexadecane, mineral oils, napthenic oils, polyisobutene and hydrogenated version of the same, and petrolatum. In some embodiments, the liquid 160 can be an ester. Examples of esters include, but are not limited to decyl oleate, decyl cocoate, dibutyl adipate, isocetyl stearate, isopropyl myristate, isopropyl palmitate, oleyl oleate, sebacate, caprillic/capric esters, and stearyl stearate. In some embodiments, the liquid 160 can be an ether, such as dioctyl ether.

The impregnating liquid 160 can include a non-solvent liquid. As described herein, some examples of non-solvent liquids can include silicone oils with straight chains or cyclic chains, fluorinated liquids, such as fluorinated hydrocarbon liquids, perfluorinated hydrocarbon liquids, fluorinated perfluoropolyether (PFPE), fluorinated silicones, aryl silicones, phenyl trimethicone, cyclomethicones, aryl cyclomethicones, mineral oil, paraffin oil, C13-C14 isoparaffins, C16-C18 isoparaffins, di and triglyceride esters, and tri alkyl esters of citric acid.

In some embodiments, the impregnating liquid 160 can be immiscible with water. In some embodiments, the liquid 160 can be immiscible with certain classes of the contact liquid 190. Some of the examples of the liquid 160 that are immiscible with certain classes of the contact liquid 190 include silicone oils, fluorinated hydrocarbons, fluorinated perfluoropolyethers, fluorinated silicones, aryl silicones, phenyl trimethicone, cyclomethicones, aryl cyclomethicones and hydrocarbon liquids including mineral oil, paraffin oil, C13-C14 isoparaffins, C16-C18 isoparaffins, di and triglyceride esters, and tri alkyl esters of citric acid. In some embodiments, the liquid 160 can be miscible with certain gel forming liquids described above with reference to gel forming materials of the solid 140.

The additive 180 can include polysaccharides, thermoplastic elastomers, and the like. Some examples of polysaccharides include xanthan gum, guar gum, cellulose gum, chitin, etc. Some examples of thermoplastic elastomers include styrene ethylene butylene styrene (SEBS), thermoplastics (TPU), cross-linked (poly) acrylic acids such as Lubrizol carbomers. The carbomers are high molecular weight, crosslinked and (poly) acrylic acid-based polymers. In some exemplary embodiments, the additive 180 can include Lubrizol polymers containing carbomer homopolymers, such as polymers of acrylic acid crosslinked with allyl sucrose or allyl pentaerythritol, carbomer homopolymers, such as polymers of acrylic acids and a C10-C30 alkyl acrylate crosslinked with allyl pentaerythritol, carbomer interpolymers that include homopolymers and/or copolymers that contain a block copolymer or polyethylene glycol and a long chain alkyl acid ester, and polycarbophil that includes a polymer of acrylic acid crosslinked with divinyl glycol, etc. In some exemplary embodiments, the additive 180 can be made to move to the interface upon application of external stimuli such as a magnetic or electric field, change in pH, change in temperature, etc. In some exemplary embodiments, the additive 180 can move to the interface without external stimuli, yet can still be actively manipulated after they move to the interface via the same external stimuli.

An interfacial modifier (IM) additive can be included in the impregnating liquid, configured such that the IM migrates to form a secondary interface and become to contact phase, in order to “cloak” the contact liquid so that the contact liquid can be insulated (or prevented) from contacting the LIS. In some embodiments, an IM can be included in the LIS to protect the LIS as well as to prolong its interfacial properties. More specifically, the IM in the LIS is may be designed to modify the interfacial rheology between the contact liquid and the LIS. An IM can be used for targeted alteration of the interface between the contact liquid or contact solid and the LIS to shield the LIS from potential damages that can be caused by the harmful effects of contact liquids. In some embodiments, the IM can be used to alter properties of the contacting phase (i.e., boundary region) at the interface, the modified region being an interface with properties that are unique from the liquid or the contacting phase.

The optional interfacial modifier can include at least one of insoluble fibers, purified wood cellulose, micro-crystalline cellulose, oat bran fiber, wax, carnauba wax, Japan wax, beeswax, candelilla wax, fructo-oligosaccharides, a metal oxide, montan wax, lignite and peat, ozokerite, ceresins, bitumens, petrolatuns, paraffins, microcrystalline wax, lanolin, an ester of metal or alkali, flour of coconut, almond, potato, wheat, pulp, zein, dextrin, cellulose ether, hydroxyethyl cellulose, hydroxypropyl cellulose (HPC), hydroxyethyl methyl cellulose, hydroxypropyl methyl cellulose (HPMC), ethyl hydroxyethyl cellulose, ferric oxide, ferrous oxide, silica, a clay mineral, bentonite, palygorskite, kaolinite, vermiculite, apatite, graphite, molybdenum disulfide, mica, boron nitride, sodium formate, sodium oleate, sodium palmitate, sodium sulfate, sodium alginate, agar, gelatin, pectin, gluten, starch alginate, carrageenan, whey, polystyrene, nylon, polypropylene, wax, polyethylene terephthalate, polypropylene, polyethylene, polyurethane, polysulphone, polyethersulfone, polytetrafluoroethylene (PTFE), tetrafluoroethylene (TFE), fluorinated ethylenepropylene copolymer (FEP), polyvinylidene fluoride (PVDF), perfluoroalkoxytetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), perfluoropolyether (PFPE), polychlorotetrafluoroethylene (PCTFE), polyvinyl alcohol (PVA), polyethyleneglycol (PEG), tecnoflon cellulose acetate, poly(acrylic acid), poly(propylene oxide), D-sorbitol, polycarbonate, a styrenic block copolymer, polystyrene-b-poly(ethylene/propylene), polystyrene-b-poly(ethylene/propylene)-b-polystyrene, polystyrene-b-poly(ethylene/butylene)-b-polystyrene, polystyrene-b-poly(ethylene-ethylene/propylene)-b-polystyrene, styrene-isoprene-styrene, a poly-olefin based thermoplastic elastomer, an ethylene-propylene random copolymer (EPM), a hydrogenated polybutadiene-isoprene-butadiene block copolymer, a polyamide based thermoplastic elastomer, polyesteramide (PEA), polyetheresteramide (PEEA), polycarbonate esteramide (PCEA), polyether-block-amide (PE-b-A), a polyacrylate based thermoplastic elastomer, poly(MMA-b-tBA-MMA), poly(MMA-b-alkyl acrylate-MMA), a mineral oil, a paraffin oil, a C13-C14 isoparaffin, a C16-C18 isoparaffin, a diglyceride ester, a triglyceride ester, a tri alkyl ester of citric acid, a glycerol diester, a glycerol triester, an ester of myristate, an adipate, a sebacate, and combinations thereof. In some embodiments, the interfacial modifier can include, for example at least one of a polysaccharide, a thermoplastic elastomer, a cross-linking polyacrylic acid, a waxy solid, or combinations thereof. In some embodiments, the interfacial modifier can include at least one of xanthan gum, guar gum, cellulose gum, chitin, styrene ethylene butylene styrene, polyethylene, polypropylene, sodium polyacrylate, polycarbophil, a carbomer, Lubrizol carbomer, calcium polyacrylate, carnauba wax, candelilla wax, beeswax, a silicone wax, a hydrocarbon wax, a perfluoropolyether grease, and combinations thereof.

The interfacial modifier can be configured to migrate to the surface of the LIS within about 1 minute after application of the LIS coating 120 to the substrate 110, within about 2 minutes, within about 5 minutes, within about 10 minutes, within about 15 minutes, within about 30 minutes, within about 60 minutes, within about 75 minutes, within about 90 minutes, within about 120 minutes, within about 180 minutes, within about 250 minutes, or within about 500 minutes.

The optional rheological modifier can include at least one of insoluble fibers, purified wood cellulose, micro-crystalline cellulose, oat bran fiber, wax, carnauba wax, Japan wax, beeswax, candelilla wax, fructo-oligosaccharides, a metal oxide, montan wax, lignite and peat, ozokerite, ceresins, bitumens, petrolatuns, paraffins, microcrystalline wax, lanolin, an ester of metal or alkali, flour of coconut, almond, potato, wheat, pulp, zein, dextrin, cellulose ether, hydroxyethyl cellulose, hydroxypropyl cellulose (HIPC), hydroxyethyl methyl cellulose. hydroxypropyl methyl cellulose (HPMC), ethyl hydroxyethyl cellulose, ferric oxide, ferrous oxide, silica, fumed silica, hydrophobic silica, hydrophilic silica, a clay mineral, bentonite, palygorskite, kaolinite, vermiculite, apatite, graphite, molybdenum disulfide, mica, boron nitride, sodium formate, sodium oleate, sodium palmitate, sodium sulfate, sodium alginate, agar, gelatin, pectin, gluten, starch alginate, carrageenan, whey, polystyrene, nylon, polypropylene, wax, polyethylene terephthalate, polypropylene, polyethylene, polyurethane, polysulphone, polyethersulfone, polytetrafluoroethylene (PTFE), tetrafluoroethylene (TFE), fluorinated ethylenepropylene copolymer (FEP), polyvinylidene fluoride (PVDF), perfluoroalkoxytetrafluoroethylene copolymer (PFA), perfluoromethyl vinylether copolymer (MFA), ethylenechlorotrifluoroethylene copolymer (ECTFE), ethylene-tetrafluomethylene copolymer (ETFE), perfluoropolyether (PFPE), polychlorotetrafluorocthylene (PCTFE), polyvinyl alcohol (PVA), polyethyleneglycol (PEG), tecnoflon cellulose acetate, poly(acrylic acid), poly(propylene oxide), D-sorbitol, polycarbonate, a styrenic block copolymer, polystyrene-b-poly(ethylene/propylene), polystyrene-b-poly(ethylene/propylene)-b-polystyrene, polystyrene-b-poly(ethylene/butylene)-b-polystyrene, polystyrene-b-poly(ethylene-ethylene/propylene)-b-polystyrene, styrene-isoprene-styrene, a poly-olefin based thermoplastic elastomer, an ethylene-propylene random copolymer (EPM), a hydrogenated polybutadiene-isoprene-butadiene block copolymer, a polyamide based thermoplastic elastomer, polyesteramide (PEA), polyetheresteramide (PEEA), polycarbonate esteramide (PCEA), polyether-block-amide (PE-b-A), a polyacrylate based thermoplastic elastomer, poly(MMA-b-tBA-MMA), poly(MMA-b-alkyl acrylate-MMA), a mineral oil, a paraffin oil, a C13-C14 isoparaffin, a C16-C18 isoparaffin, a diglyceride ester, a triglyceride ester, a tri alkyl ester of citric acid, a glycerol diester, a glycerol triester, an ester of myristate, an adipate, a sebacate, and combinations thereof.

In some embodiments, the theological modifier can be a plurality of particles added to the liquid 160. In some embodiments, the rheological modifier can be a fluid material added to the liquid 160. In some embodiments, the liquid 160 can be selected from among materials that inherently have one or more desired theological properties such that no rheological modifier is necessary. In some embodiments, the rheological modifier can be added to increase shear strength of the liquid. In some embodiments, the rheological modifier can be added to increase the viscosity of the liquid 160. In some embodiments, the theological modifier can be added to increase the rate of retention of the liquid 160 on the substrate 110.

In some embodiments, the rheological modifier can be in the form of particles having an average dimension of between about 1 nm and about 50 um, between about 10 nm and about 45 um, between about 25 nm and about 40 um, between about 50 nm and about 35 um, between about 100 nm and about 30 um, between about 500 nm and about 29 um, between about 750 nm and about 28 um, between about 1 um and about 27 um, between about 2 um and about 26 um, between about 3 um and about 25 um, between about 4 um and about 24 um, between about 20 nm and about 30 um, between about 20 nm and about 25 um, between about 20 nm and about 20 um, between about 20 nm and about 15 um, between about 20 nm and about 10 um, between about 20 nm and about 5 um, between about 10 nm and about 4 um, between about 10 nm and about 3 um, between about 10 nm and about 2 um, between about 10 nm and about 1 um, between about 50 nm and about 10 um, between about 50 nm and about 9 um, between about 50 nm and about 8 um, between about 50 nm and about 7 um, between about 50 nm and about 6 um, between about 50 nm and about 5 um, between about 50 nm and about 4 um, between about 50 nm and about 3 um, between about 50 nm and about 2 um, or between about 50 nm and about 1 um, inclusive of all values and ranges therebetween.

In some embodiments, particles can consist of, for example but not limited to, insoluble fibers (e.g., purified wood cellulose, micro-crystalline cellulose, and/or oat bran fiber), wax (e.g., amide wax, ethylene-bis(stearamide) wax carnauba wax, Japan wax, beeswax, candelilla wax), polyethylene, a polytetrafluoroethylene, a polypropylene, other polysaccharides, fructo-oligosaccharides, metal oxides, montan wax, lignite and peat, ozokerite, ceresins, bitumens, petrolatuns, paraffins, microcrystalline wax, lanolin, esters of metal or alkali, flour of coconut, almond, potato, wheat, pulp, zein, dextrin, cellulose ethers (e.g., Hydroxyethyl cellulose, Hydroxypropyl cellulose (HPC), Hydroxyethyl methyl cellulose, Hydroxypropyl methyl cellulose (HPMC), Ethyl hydroxyethyl cellulose), ferric oxide, ferrous oxide, silicas, clay minerals, bentonite, palygorskite, kaolinite, vermiculite, apatite, graphite, molybdenum disulfide, mica, boron nitride, sodium formate, sodium oleate, sodium palmitate, sodium sulfate, sodium alginate, agar, gelatin, pectin, gluten, starch alginate, carrageenan, whey, polystyrene, nylon, polypropylene, wax, polyethylene terephthalate, polypropylene, polyethylene, polyurethane, polysulphone, polyethersulfone, polytetrafluoroethylene (PTFE), tetrafluoroethylene (TFE), fluorinated ethylenepropylene copolymer (FEP), polyvinylidene fluoride (PVDF), perfluoroalkoxyltetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), perfluoropolyether (PFPE), polychlorotetrafluoroethylene (PCTFE), polyvinyl alcohol (PVA), polyethyleneglycol (PEG), Tecnoflon cellulose acetate, poly(acrylic acid), poly(propylene oxide), D-sorbitol, polycarbonate, one or more members from the following list of Styrenic Block copolymers, including but not limited to, SEP: Polystyrene-b-poly(ethylene/propylene), SEPS: Polystyrene-b-poly(ethylene/propylene)-b-polystyrene, SEBS: Polystyrene-b-poly(ethylene/butylene)-b-polystyrene, SEEPS: Polystyrene-b-poly(ethylene-ethylene/propylene)-b-polystyrene, SIS: Styrene-Isoprene-Styrene; one or more members from the following list of Poly-olefin based thermoplastic elastomers, including but not limited to, Ethylene-Propylene random copolymer (EPM), Hydrogenated polybutadiene-isoprene-butadiene block copolymer, one or more members from the following list of Polyamide based thermoplastic elastomers, including but not limited to, Polyesteramides (PEA), Polyetheresteramides (PEEA), Polycarbonate esteramides (PCEA), Polyether-block-amides (PE-b-A); and one or more members from the following list of Polyacrylate based thermoplastic elastomers, including but not limited to, Poly(MMA-b-tBA-MMA) and Poly(MMA-b-alkyl acrylate-MMA), any other material described or listed herein, or any combination thereof.

In some embodiments, particles can range in size from about 10 nm to about 100 um, from about 50 nm to about 50 um, from about 500 nm to about 25 um, from about 500 nm to about 20 um, about 1 um to about 15 um, about 3 um to about 10 um, or from about 750 nm to about 50 um, from about 500 nm to about 20 um, inclusive of all values and ranges therebetween. In some embodiments, the particles can be substantially uniform in size. In some embodiments, the particles can be substantially non-uniform in size. In some embodiments, the particles can be porous, with pores ranging in size from about 5 nm to about 5 um, from about 5 nm to about 500 nm, from about 5 nm to about 50 nm, from about 5 nm to about 250 nm, from about 50 nm to about 500 nm, from about 500 nm to about 5 um, from about 500 nm to about 4 um, from about 1 um to about 3 um, or from about 500 nm to about 2 um, inclusive of all values and ranges therebetween. In some embodiments, the particles can be shaped, coated, treated, charged, magnetized, irradiated, chemically treated, heated, cooled, excited, bombarded with energy, hardened, weakened, attached, modified according to any other method known in the art.

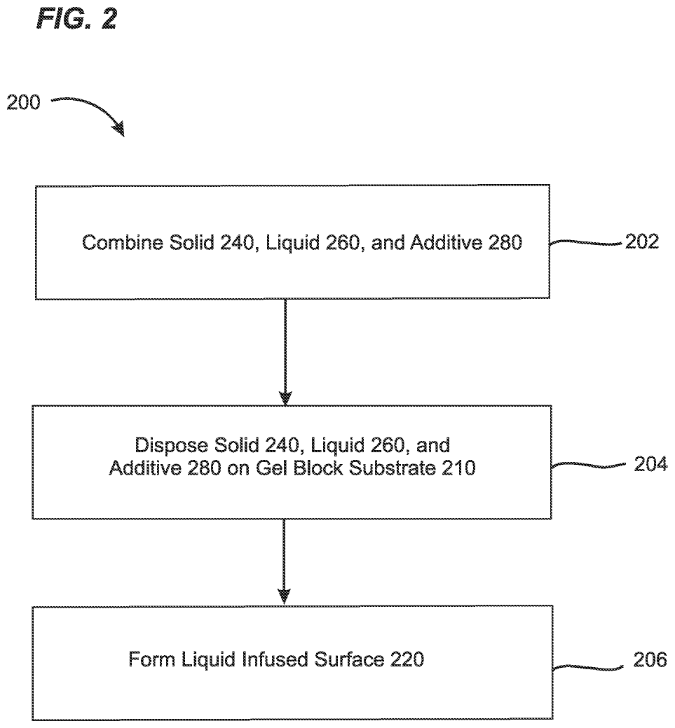

FIG. 2 shows a process flow diagram describing a manufacturing method 200 for preparing an LIS 220, according to an embodiment. The manufacturing method 200 includes combining a solid 240, a liquid 260, and an additive 280, at step 202. The solid 240 can be any of the solids 140 described above with reference to FIG. 1, the liquid 260 can be any of the liquids 160 described above with reference to FIG. 1, and the additive 280 can be any of the additive 180 described above with reference to FIG. 1. The solid 240, the liquid 260, and the additive 280 can be combined in a container and agitated or stirred, or any other type or form of mixing, shaking. In some embodiments, the resulting mixture of the solid 240, the liquid 260, and the additive 280 can be in the form of liquid, semi-solid, slurry, gel, or paste.

After the mixture of the solid 240, the liquid 260, and, the additive 280 is produced, the mixture is disposed onto the gel block substrate 210, at step 204. The gel block substrate may be a textured gel block substrate. In some embodiments, the mixture can be disposed on the substrate 210 to form a substantially continuous coating. In some embodiments, the mixture of the solid 240, the liquid 260, and the additive 280 can be disposed on the substrate 210 while the substrate 210 is spinning (e.g., a spin coating process). In some embodiments, the mixture of the solid 240, the liquid 260, and the additive 280 can be condensed onto the substrate 210. In some embodiments, the mixture of the solid 240, the liquid 260, and the additive 280 can be applied by depositing the mixture of the solid 240, the liquid 260, and the additive 280 with one or more volatile liquids and evaporating away the one or more volatile liquids. In some embodiments, the mixture of the solid 240, the liquid 260, and the additive 280 can be applied using a spreading (non-viscous) liquid that spreads or pushes the liquid 260 and/or the additive 280 along the surface of the substrate 210. The non-viscous flow of the combined solution traversing on the surface of the substrate 210 may distribute the mixture of the solid 240, the liquid 260, and the additive 280 uniformly across the surface of the substrate 210.

After the solid 240, the liquid 260, and the additive 280 have been disposed on the substrate 210, a LIS 220 is formed at step 206. As described above, the LIS 220 can include a microscopically smooth uniform LIS 220 coating on the substrate 210. In some embodiments, the LIS 220 coating can also be a macroscopically smooth coating. In some embodiments, the volume percentage of the LIS 220 that is solid (solid concentration) can be within a range of 5% to 90% of solid 240 in the liquid 260, or in the range of 1% to 20% of solid in the liquid. This solid concentration can result in a very low fraction of the solid that is non-submerged by the liquid (˜.<2%).

In some embodiments, the LIS 220 can have a coating thickness in a range of from about 1 nm to about 10 nm, about 10 nm to about 100 nm, about 100 nm to about 200 nm, about 200 nm to about 300 nm, about 300 nm to about 400 nm, about 400 nm to about 500 nm, about 500 nm to about 600 nm, about 600 nm to about 700 nm, about 700 nm to about 800 nm, about 800 nm to about 900 nm, about 900 nm to about 1 um, about 1 um to about 5 um, about 5 um to about 10 um, about 10 um to about 50 um, about 50 um to about 100 um, about 100 um to about 200 um, about 200 um to about 300 um, about 300 um to about 400 um, about 400 um to about 500 um, about 500 um to about 600 um, about 600 um to about 700 um, about 700 um to about 800 um, about 800 um to about 900 um, about 900 um to about 1 mm, or about 1 mm to about 10 mm, and any thickness in the ranges therebetween.

FIG. 3 shows a process flow diagram describing a manufacturing method 300 for preparing an LIS 320, according to an embodiment. The manufacturing method 300 includes disposing a solid 340 onto the gel block substrate 310 at step 302. The solid 340 can be any of the solids 140 described above with reference to FIG. 1. The gel block substrate 310 may be a textured gel block substrate. For example, the gel block substrate 310 can be treated with the solid 340 by dusting, or by spraying, painting, or brushing the additive in a volatile suspension liquid onto the substrate 310. The volatile suspension liquid may be, for example, ethanol or isopropanol. In some embodiments, the solid 340 can be applied by depositing a mixture of the solid 340 with one or more volatile suspension liquids and evaporating away the one or more volatile suspension liquids.

After the solid 340 is disposed onto the substrate 310, the liquid 360 is disposed on the solid 340 already disposed on the substrate 310 at step 304. As described herein, the liquid 360 can be any of the liquids 160 described above with reference to FIG. 1. In some embodiments, the mixture can be disposed on the substrate 310 to form a substantially continuous coating.

After the solid 340 and the liquid 360 are disposed on the substrate 310 forming a liquid impregnated surface, optionally an additive 380 can be disposed onto the previously disposed liquid impregnated surface comprising the mixture of the solid 340 and the liquid 360, at step 306. As described herein, the additive 380 can be any of the additive 180 described above with reference to FIG. 1.

After the additive 380 has been disposed onto the previously deposited liquid impregnated surface comprising the solid 340 and the liquid 360 on the substrate 310, an LIS 320 is formed at step 308. The LIS 320 can include the additive 380 disposed on the liquid impregnated surface comprising the solid 340 and the liquid 360, which can be a microscopically smooth uniform LIS 320 coating on the substrate 310. In some embodiments, the LIS 320 coating can also be a macroscopically smooth coating. In some embodiments, the LIS 320 coating can appear as particles sprinkled onto a liquid impregnated surface. The method of disposing the additive 380 can be any method or processes that have been described herein and in various referenced applications incorporated by reference herein. In some embodiments, the average solid concentration of the LIS 320 can be within a range of 5% to 90% of solid 340 in the liquid 360. This solid concentration can result in a very low portion of the solid that is non-submerged by the liquid (˜<2%).

In some embodiments, the LIS 320 can have a coating thickness of about 1 nm to about 10 nm, about 10 nm to about 100 nm, about 100 nm to about 200 nm, about 200 nm to about 300 nm, about 300 nm to about 400 nm, about 400 nm to about 500 nm, about 500 nm to about 600 nm, about 600 nm to about 700 nm, about 700 nm to about 800 nm, about 800 nm to about 900 nm, about 900 nm to about 1 um, about 1 um to about 5 um, about 5 um to about 10 um, about 10 um to about 50 um, about 50 um to about 100 um, about 100 um to about 200 um, about 200 um to about 300 um, about 300 um to about 400 um, about 400 um to about 500 um, about 500 um to about 600 um, about 600 um to about 700 um, about 700 um to about 800 um, about 800 um to about 900 um, about 900 um to about 1 mm, or about 1 mm to about 10 mm, and any thickness in the ranges therebetween.

In some embodiments, the solid 140 and the liquid 360 can be combined in a container and agitated or stirred, or any other type or form of mixing, shaking, and centrifuging. In some embodiments, the resulting mixture of the solid 140 and the liquid 160 can be in the form of liquid, semi-solid, slurry, gel, or paste.

Once a mixture of the solid 140 and the liquid 160 is produced, the mixture is disposed onto the substrate 110. In some embodiments, the mixture can be disposed on the substrate 110 to form a substantially continuous coating.

In some embodiments, the mixture of the solid 140 and the liquid 160 can be disposed on the substrate 110 while the substrate 110 is spinning (e.g., a spin coating process). In some embodiments, the mixture of the solid 140 and the liquid 160 can be condensed onto the substrate 110. In some embodiments, the mixture of the solid 140 and the liquid 160 can be applied by depositing the mixture of the solid 140 and the liquid 160 with one or more volatile liquids (e.g., via any of the previously described methods) and evaporating away the one or more volatile liquids. In some embodiments, the mixture of the solid 140 and the liquid 160 can be applied using a spreading, low viscosity liquid that spreads or pushes the liquid 160 along the surface of the substrate 110. The non-viscous flow of the combined solution traversing on the surface of the substrate 110 may distribute the mixture of the solid 140 and the liquid 160 uniformly across the surface of the substrate 110.

A method of forming the LIS 120 can include disposing a composition (e.g., the LIS coating) on the substrate 110 to form the durable lubricious surface 120. In some embodiments, the composition can include a liquid, a first plurality of particles, and a second plurality of particles. The composition can include any composition of the LIS coating 120 or any other composition described herein. By way of example only, the composition can include the liquid 160, the plurality of particles 140, the interfacial modifier 180, and/or a rheological modifier 170. In some embodiments, the various materials comprising the composition can be mixed together to form the composition and the composition can be applied to the substrate 110. In some embodiments, one or more of the materials comprising the composition can be mixed together to form an intermediate material, the intermediate material can be applied to the substrate 110, and one or more of the remaining materials comprising the composition can be added to the intermediate material to form the composition. In some embodiments, each of the materials comprising the composition can be disposed to the substrate 110 to collectively form the composition on the substrate. The method further includes disposing a contacting phase on the lubricious surface and allowing at least a portion of the second plurality of particles to migrate to the contacting phase. The contacting phase (i.e., contact liquid, contacting liquid, or product) can include any of the materials as described herein. In some embodiments, the LIS 120 can be formed by depositing the composition to the substrate 110 to form a composition-coated substrate, depositing the contacting phase onto the composition-coated substrate to form the LIS 120, and allowing at least a portion of the composition to migrate into the contacting phase.

In some embodiments, the LIS can have a first lubricity in a first configuration without the additive and/or IM and a second lubricity in a second configuration including the additive and/or IM. In some embodiments, the first lubricity can be less than the second lubricity. In some embodiments, the first lubricity can be less than about 99%, 95%, 90%, 80%, 70%, 60%, 50%, 40%, 30%, 20%, or 10% of the second lubricity.

### EXAMPLES

### Examples 1-7. Method of Making Silicone Dry Gels

The gel block may be a silicone dry gel. Silicone dry gels were synthesized according to the following examples as disclosed in U.S. Pat. No. 9,556,336. First and second set of components were prepared as shown in Table 1.

TABLE 1
Silicone Dry Gel Compositions

| | | | | | |
|---|---|---|---|---|---|
| Example 1 | Example 2 | Example 3 | Example 4 | Example 5 | Example 6 |
| Wt. % | Wt. % | Wt. % | Wt. % | Wt. % | Wt. % |

1st set of Components

| | | | | | | |
|---|---|---|---|---|---|---|
| V-PDMS, | 99.917 | 99.917 | 99.917 | 99.917 | 99.917 | 99.917 |
| Gelest DMS- | | | | | | |
| 35 | | | | | | |
| Platinum | 0.083 | 0.083 | 0.083 | 0.083 | 0.083 | 0.083 |
| Catalyst | | | | | | |

2nd set of Components

| | | | | | | |
|---|---|---|---|---|---|---|
| V-PDMS, | 98.719 | 97.64 | 97.593 | 97.509 | 97.439 | 97.467 |
| Gelest DMS- | | | | | | |
| 35 | | | | | | |
| Crosslinker, | 0.329 | 0.2790 | 0.284 | 0.294 | 0.302 | 0.299 |
| Gelest | | | | | | |
| 7278.0 | | | | | | |
| Chain | 1.552 | 2.0450 | 2.083 | 2.157 | 2.194 | 2.219 |
| extender, | | | | | | |
| Gelest DMS- | | | | | | |
| H03 | | | | | | |
| Inhibitor, | 0.04 | 0.04 | 0.04 | 0.04 | 0.04 | 0.04 |
| Aldrich | | | | | | |
| 27,839-4 | | | | | | |
| Hardness | 40 g | 75 g | 95 g | 145 g | 180 g | 205 |

A first set of components was prepared. To prepare the first set of components, a platinum catalyst complex (Platinum divinyltetramethyldisiloxane complex; SIP 6830.3, Gelest Inc.) is added to a container. Vinyl-terminated polydimethylsiloxane (V-PDMS; DMS V35; Gelest, Inc.) is combined with the catalyst. The catalyst is added first to the bottom of the container. After adding the catalyst the V-PDMS can be added by pouring it into the container. Mixing is started at low rpm (100 rpm) and gradually increasing to 500 rpm in 2 minutes. After the 2 minutes mixing, the mixing speed can be increased to 1200-1400 rpm for 3 minutes.

A second set of components was prepared. A vinyl-terminated polydimethylsiloxane (V-PDMS; DMS V35; Gelest, Inc.) was added to a crosslinker, tetrakis(dimethylsiloxy)silane (GELEST SIT 7278.0), and a chain extender (hydride-terminated polydimethylsiloxane; GELEST DMS-H03). The crosslinker was added to the container first, because small variations in the added amount can greatly influence the hardness of the gel. Next, the inhibitor was added to the reaction container. The chain extender was added next. Mixing was started at low rpm (100 rpm), then after 2 minutes increased to 500 rpm, then increased mixing speed to 1200-1400 rpm for 3 minutes.

The first set of components was mixed with the second set of components at 1:1 ratio in a vial. The two sets of components were mixed at 1250 rpm for 2-3 minutes, placed under vacuum for 4-5 minutes, and poured into the desired mold. The resulting molded mixture was placed under vacuum for 3 minutes and then cured for 30 minutes at 90° C. to form dry silicone gel blocks.

Additional additives may be added to the first set of components. The additional additives may include at least one material selected from the group consisting of Dynasylan 40, PDM 1922, Songnox 1024, Kingnox 76, DHT-4A, Kingsorb, pigment, and mixtures thereof. In some embodiments, the additives comprise between 0.1 and 5 wt %, between 0.1 and 2 wt %, or between 0.1 and 1 wt % of the first set composition. Physical properties of silicone gels including hardness were tested.

### Example 8: Silicone Dry Gel Composition

A silicone dry gel composition comprising certain additional additives was prepared as shown in Table 2.

TABLE 2
Silicone dry gel composition

| | | | | Total wt | |
|---|---|---|---|---|---|
| Component | Description | wt | wt % A | % | Supplier |
| V-PDMS | Vinyl terminated | 148.71 | 96.968 | 97.2376 | DMS V- |
| | polydimethyl | | | | 35, Gelest |
| | siloxane | | | | Inc., 5000 |
| | | | | | cSt |
| Platinum | Platinum | 0.15 | 0.098 | 0.0494 | SIP |
| Catalyst | divinytetramethyldisiloxane | | | | 6830.3, |
| | complex | | | | Gelest Inc. |
| PDM 1922 | Diphenylsiloxane- | 1.00 | 0.652 | 0.3296 | PDM |
| | dimethysiloxane | | | | 1922, |
| | copolymer | | | | Gelest Inc. |
| Antioxidant | Isotridecyl-3-(3,5- | 1.00 | 0.652 | 0.3296 | SONGNOX |
| | di-t-butyl-4- | | | | 1077, |
| | hydroxyphenyl) | | | | Songwon |
| | Proprionate | | | | |
| Pigment | Gelest Black | 2.50 | 1.630 | 0.8241 | PGBLK01, |
| | Pigment | | | | Gelest |
| | | | | | Inc. |
| | TOTAL A | 153.36 | 100.000 | | |

B side

| | | wt | wt % B | | |
|---|---|---|---|---|---|
| V-PDMS | Vinyl terminated | 146.27 | 97.513 | | DMS V- |
| | polydimethyl | | | | 35, Gelest |
| | siloxane | | | | Inc., 5000 |
| | | | | | cSt |
| Crosslinker | Tetrakis | 0.4470 | 0.298 | 0.1473 | SIT |
| | (dimethylsiloxy) | | | | 7278.0, |
| | silane (MH4Q) | | | | Gelest Inc. |
| Chain | hydride teminated | 3.2830 | 2.189 | 1.0822 | DMS- |
| extender | polydimethyl | | | | H03, |
| | siloxane | | | | Gelest Inc. |
| | TOTAL B | 150.00 | 100.000 | 100.0000 | |
| | TOTAL A + B | 303.36 | | | |

The silicone dry gel of example 7 was prepared as shown above. Final hardness of example 7 was 110 g by Texture Analyzer.

### Example 9. Tackiness of Cured Dry Silicone Gel Samples without Surface Treatment

Silicone dry gel blocks were prepared, molded, cured, and sent to lab for testing. No surface treatments were employed in comparative testing. Tack force measurements were obtained using a Texture Analyzer. A Brookfield RAY-K-00184 Texture Analyzer with cylindrical aluminum probe with diameter 20 mm, 700 g Aluminum probe depth, trigger load 4 g, probe speed 2.0 mm/sec, and hold time of 15 sec was employed in making the tack measurements. Qualification samples, production samples from an aluminum mold, and aged silicone gel samples were evaluated. Samples were tested as received, or after cutting 2-5 mm of surface. Results are shown in Tables 3A-3E. An aged dry silicone gel that was aged for approximately 8 months in age was evaluated in Table 3E.

TABLE 3A
Untreated dry silicone gel qualification samples

| | tack time | Neg adhesive | adhesiveness |
|---|---|---|---|
| Tackiness | (s) | Force (g) | (mJ) |
| sample 1 | 1.16 | 367.7 | 5.0 |
| sample 2 | 0.96 | 291.9 | 3.7 |
| sample 3 | 0.93 | 334.3 | 3.6 |
| Average | 1.02 | 331 | 4.1 |
| St dev | 0.13 | 38 | 0.8 |

TABLE 3B
Untreated dry silicone gel production samples

| | tack time | Neg adhesive | adhesiveness |
|---|---|---|---|
| Tackiness | (s) | Force (g) | (mJ) |
| sample 1 | 1.27 | 412.3 | 6.2 |
| sample 2 | 1.38 | 411.7 | 7.4 |
| sample 3 | 1.25 | 362.8 | 6.0 |
| Average | 1.30 | 396 | 6.5 |
| St dev | 0.07 | 28 | 0.77 |

TABLE 3C
Untreated dry silicone gel qualification samples
after cutting away 2-5 mm of surface

| | tack time | Neg adhesive | adhesiveness |
|---|---|---|---|
| Tackiness | (s) | Force (g) | (mJ) |
| sample 1 | 1.27 | 175.2 | 2.9 |
| sample 2 | 1.13 | 237.2 | 3.4 |
| sample 3 | 1.34 | 331.8 | 5.5 |
| Average | 1.25 | 248.1 | 4.0 |
| St dev | 0.11 | 78.9 | 1.4 |

TABLE 3D
Untreated dry silicone gel production samples
after cutting away 2-5 mm of surface

| | tack time | Neg adhesive | adhesiveness |
|---|---|---|---|
| Tackiness | (s) | Force (g) | (mJ) |
| sample 1 | 1.21 | 226.0 | 3.7 |
| sample 2 | 1.37 | 340.3 | 5.9 |
| sample 3 | 1.45 | 313.3 | 5.8 |
| Average | 1.34 | 293.2 | 5.1 |
| St dev | 0.12 | 59.74 | 1.21 |

TABLE 3E
Untreated dry silicone gel aged greater than 8 months

| | tack time | Neg Adhesive | adhesiveness |
|---|---|---|---|
| Tackiness | (s) | Force (g) | (mJ) |
| sample 1 | 1.58 | 762.60 | 12.79 |
| sample 2 | 1.54 | 769.20 | 13.87 |
| sample 3 | 1.89 | 772.90 | 16.47 |
| sample 4 | 1.95 | 887.00 | 21.32 |
| sample 5 | 1.55 | 784.80 | 12.75 |
| Average | 1.70 | 795 | 15.44 |
| St dev | 0.20 | 52 | 3.62 |

For untreated silicone dry gel qualification samples (Table 3A-3B) and for samples wherein 2-5 mm surface layer had been removed (Table 3C-3D) the average negative adhesive force (g) to remove probe from gel was greater than 200 g. For aged 8 month untreated silicone dry gel samples, the average negative adhesive force was very high; greater than 700 g, as shown in Table 3E. All samples exhibited tack time to Aluminum probe without surface treatment of greater than about 1 second.

For untreated silicone dry gel qualification samples without surface treatment the average adhesiveness was high; greater than about 4 mJ (Table 3A). Average adhesiveness for production samples was greater than 6 mJ (Table 3B).

For untreated silicone dry gels without surface treatment having 2-5 mm surface cut away average adhesiveness was greater than about 3.5 mJ (Tables 3C-3D). Average adhesiveness for untreated aged >8 month production samples was very high; greater than about 12 mJ.

Measurement of gel-gel adhesion for comparative untreated dry silicone gel samples without surface treatment was also measured by covering aluminum probe with untreated dry silicone gel. When measurable, the negative adhesive force for gel-gel adhesion was greater than about 200 g, tack time greater than about 2 s, and adhesiveness was greater than 5 mJ.

### Example 10. Tackiness of Cured Dry Silicone Gel Samples with Surface Treatment

In this example, gel block surface treatment was applied to all surfaces of cured silicone dry gel blocks and tack force was measured to determine influence on tack time (s), adhesiveness (mJ), and average negative force (g) to remove probe from gel over time.

Specifically, dry silicone gel blocks were molded and one week later surfaces were left untreated or treated by spraying with a solid particle 140, specifically, synthetic micronized polypropylene wax (MICROPRO 400)(n=3 each condition). No liquid 160 was applied. The samples were sent to lab for testing.

Tack force measurements were obtained using a Texture Analyzer. A Brookfield RAY-K-00184 Texture Analyzer with cylindrical aluminum probe with diameter 20 mm, trigger load 4 g, probe speed 2.0 mm/sec, and hold time of 15 sec was employed in making the tack measurements. The tack time (s), negative adhesive force (g), and adhesiveness (mJ) measurements were obtained for each sample. Test blocks of silicone gel were measured per time point indicated.

Fresh blocks were employed for each time point, for example, at t=0, t=1 week, and t=3 weeks. Each block was tested at 3 positions over the length (left, middle, right) away from the edge of the block.

### Results

Untreated dry silicone gel samples were difficult to measure because the gel block sticks too hard on the probe. Measurements were obtained for a single untreated control sample at t=0 where tack time was 1.97 seconds, negative adhesive force was 328 g, and adhesiveness was 8 mJ. Remaining untreated control samples (t=1 wk) and (t=3 wk) were not measurable and stuck enormously on probe, illustrating one problem to be solved.

Tackiness was significantly reduced for silicone dry gel samples having surface treated with micronized polypropylene wax (Micropro 400) over time=0, 1, and 3 weeks. For dry silicone gel blocks sprayed with micronized polypropylene wax, for each time point, tack time was reduced to no more than 0.8 seconds, Negative adhesive force was reduced to no more than 160 g, and adhesiveness was reduced to no more than 1.5 mJ, or no more than 1 mJ. It is anticipated that application of impregnating liquid 160 to silicone dry gel substrate treated with solid particle 140 will further durably reduce tack time, negative adhesive force, and adhesiveness over time.

### Example 11. Force to Open Closures Sealed with Dry Silicone Gel with and without Surface Treatment

Two closures with silicone dry gel seals surface treated by particle deposition of a synthetic, micronized hydrocarbon wax solid particle 140 (a polypropylene having a melting point from about 140° C. to about 143° C. and a mean particle size from about 4.5 μm to about 7.5 μm) were tested compared to a closure with a silicone dry gel seal that was not surface treated. No impregnating liquid 160 was employed. The closures were shut, aged for 7 days at 65° C. without humidity. They were then placed in a −5° C. chamber for 24 hours. The closures were removed from the chamber to ambient conditions (20° C.) and tested within one minute. The closures were then opened by pulling apart with an Instron© universal test machine. The base of the closure was held stationary and the lid was moved at a rate of 500 mm/min. A pulley was used to distribute the pulling force so there was no side load on the Instron© load cell.

Specimen 1 was the closure silicone dry gel seal without the solid particle 140 treatment. Specimen 2 and specimen 3 were the closure silicone dry gel seals with the solid particle 140 treatment without impregnating liquid 160. Specimen 1 required a maximum load of 32.70 lbf to separate the closure. Specimen 2 required a maximum load of 1.45 lbf to separate the closure. Specimen 3 required a maximum load of 4.59 lbf to separate the closure. Thus, specimen 2 and specimen 3 required substantially reduced force for separation compared to specimen 1 without the additive, which was very difficult to separate. The two closures containing the silicone gel surface treated with Micropro 400 solid particle 140 were opened after less than 5 lbs of force (lbf) (<22 N) were applied while the closure with untreated silicone gel required over 30 lbs of force (lbf) (>130 N) to open. This example illustrates that the additive significantly reduces the tackiness of the silicone dry gel. It is anticipated that application of impregnating liquid 160 to silicone dry gel substrate treated with solid particle 140 will further durably force to open sealed closure over time.

From the foregoing detailed description, it will be evident that modifications and variations can be made to the gels and additives disclosed herein without departing from the spirit or scope of the disclosure.

1. A method for preparing an elastomeric gel block having a lubricious surface comprising
treating at least one surface of an elastomeric gel block substrate to create at least one textured surface;
disposing a composition on the at least one textured surface to form a lubricious surface, the composition comprising an impregnating liquid.

2. The method of claim 1, wherein the elastomeric gel block is selected from the group consisting of a silicone gel block, a polyurethane gel block, a thermoplastic elastomer gel block, and a hybrid thermoplastic elastomer gel block.

3. The method of claim 2, wherein the silicone gel block is selected from the group consisting of a silicone dry gel block and a silicone oil gel block.

4. The method of claim 1, wherein the elastomeric gel block exhibits one or more of the following properties:
an H₆₀ₛ hardness in the range of 40 to 250 g, 50 to 150 g, or about 60 to about 120 g;
a final load hardness from 40 to 250 g, 50 to 150 g, or 60 to 120 g when measured by a texture analyzer;
a durometer hardness in the range of 10 to 53 Shore OOO, 17 to 42 Shore OOO, or 23 to 37 Shore OOO when measured by ASTM D2240.

5. The method of claim 1, wherein the treating at least one surface comprises a treatment selected from the group consisting of laser cutting, engraving, scoring, wet etching, photolithography, sol-gel synthesis, 3D printing, layer-by-layer deposition, particle deposition, chemical treatment, and functionalization of the at least one surface.

6. The method of claim 1, wherein the textured surface exhibits a complexity of equal to or greater than 10%.

7. The method of claim 1, wherein the composition further comprises a first plurality of particles.

8. The method of claim 7, wherein the first plurality of particles is selected from the group consisting of hydrocarbon wax, amide wax, ethylene-bis(stearamide) wax, carnauba wax, Japan wax, beeswax, candelilla wax, polyethylene, polytetrafluoroethylene, polypropylene, fructo-oligosaccharides, metal oxides, montan wax, lignite, peat, ozokerite, ceresins, bitumens, petrolatuns, paraffins, microcrystalline wax, lanolin, esters of metal or alkali, flour of coconut, almond, potato, wheat, pulp, zein, dextrin, hydroxyethyl cellulose, hydroxypropyl cellulose (HPC), hydroxyethyl methyl cellulose, hydroxypropyl methyl cellulose (HPMC), ethyl hydroxyethyl cellulose, ferric oxide, ferrous oxide, silicas, clay minerals, bentonite, palygorskite, kaolinite, vermiculite, apatite, graphite, molybdenum disulfide, mica, boron nitride, sodium formate, sodium oleate, sodium palmitate, sodium sulfate, sodium alginate, agar, gelatin, pectin, gluten, starch alginate, carrageenan, whey, polystyrene, nylon, polypropylene, wax, polyethylene terephthalate, polypropylene, polyethylene, polyurethane, polysulphone, polyethersulfone, polytetrafluoroethylene (PTFE), tetrafluoroethylene (TFE), fluorinated ethylenepropylene copolymer (FEP), polyvinylidene fluoride (PVDF), perfluoroalkoxyltetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), perfluoropolyether (PFPE), polychlorotetrafluoroethylene (PCTFE), polyvinyl alcohol (PVA), polyethyleneglycol (PEG), Tecnoflon cellulose acetate, poly(acrylic acid), poly(propylene oxide), D-sorbitol, polycarbonate, one or more members from the following list of Styrenic Block copolymers, including but not limited to, SEP: Polystyrene-b-poly(ethylene/propylene), SEPS: Polystyrene-b-poly(ethylene/propylene)-b-polystyrene, SEBS: Polystyrene-b-poly(ethylene/butylene)-b-polystyrene, SEEPS: Polystyrene-b-poly(ethylene-ethylene/propylene)-b-polystyrene, SIS: Styrene-Isoprene-Styrene; ethylene-propylene random copolymer (EPM), hydrogenated polybutadiene-isoprene-butadiene block copolymer, one or more members from the following list of Polyamide based thermoplastic elastomers, including but not limited to, Polyesteramides (PEA), Polyetheresteramides (PEEA), Polycarbonate esteramides (PCEA), Polyether-block-amides (PE-b-A); and polyacrylate based thermoplastic elastomers.

9. The method of claim 1, wherein the impregnating liquid is selected from the group consisting of silicone oils, fluorinated hydrocarbons, fluorinated perfluoropolyethers, fluorinated silicones, aryl silicones, phenyl trimethicone, cyclomethicones, aryl cyclomethicones and hydrocarbon liquids including mineral oil, paraffin oil, C₁₃-C₁₄ isoparaffins, C₁₆-C₁₈ isoparaffins, di glyceride esters of citric acid, and triglyceride esters of citric acid, and tri alkyl esters of citric acid.

10. The method of claim 1, wherein the composition further comprises a component selected from an additive, interfacial modifier, and rheological modifier.

11. The method of claim 1, wherein the elastomeric gel block lubricious surface exhibits one or more of
a roll off angle of no more than about 5 degrees;
an adhesiveness of no more than 2.5 mJ when measured by texture analyzer;
a negative adhesive force of no more than 170 g when measured by texture analyzer; and
a tack time of no more than 1.0 seconds when measured by texture analyzer.

12. An elastomeric gel block having a lubricious surface comprising
a textured surface infused with an impregnating liquid, wherein the lubricious surface exhibits a roll off angle of no more than about 5 degrees.

13. The elastomeric gel block of claim 12, wherein the gel block is selected from the group consisting of a silicone gel block, a polyurethane gel block, a thermoplastic elastomer gel block, and a hybrid thermoplastic elastomer gel block.

14. The elastomeric gel block of claim 13, wherein the silicone gel block is selected from the group consisting of a silicone dry gel block and a silicone oil gel block.

15. The elastomeric gel block of claim 12, wherein the elastomeric gel block exhibits one or more of the following properties:
an H₆₀ₛ hardness in the range of 40 to 250 g, 50 to 150 g, or about 60 to about 120 g;
a final load hardness from 40 to 250 g, 50 to 150 g, or 60 to 120 g when measured by a texture analyzer;
a durometer hardness in the range of 10 to 53 Shore OOO, 17 to 42 Shore OOO, or 23 to 37 Shore OOO when measured by ASTM D2240.

16. The elastomeric gel block of claim 12, wherein the textured surface exhibits a complexity of equal to or greater than 10%.

17. The elastomeric gel block of claim 12, wherein the impregnating liquid comprises a first plurality of particles.

18. The elastomeric gel block of claim 17, wherein the first plurality of particles is selected from the group consisting of hydrocarbon wax, amide wax, ethylene-bis(stearamide) wax, carnauba wax, Japan wax, beeswax, candelilla wax, polyethylene, polytetrafluoroethylene, polypropylene, fructo-oligosaccharides, metal oxides, montan wax, lignite, peat, ozokerite, ceresins, bitumens, petrolatuns, paraffins, microcrystalline wax, lanolin, esters of metal or alkali, flour of coconut, almond, potato, wheat, pulp, zein, dextrin, hydroxyethyl cellulose, hydroxypropyl cellulose (HPC), hydroxyethyl methyl cellulose, hydroxypropyl methyl cellulose (HPMC), ethyl hydroxyethyl cellulose, ferric oxide, ferrous oxide, silicas, clay minerals, bentonite, palygorskite, kaolinite, vermiculite, apatite, graphite, molybdenum disulfide, mica, boron nitride, sodium formate, sodium oleate, sodium palmitate, sodium sulfate, sodium alginate, agar, gelatin, pectin, gluten, starch alginate, carrageenan, whey, polystyrene, nylon, polypropylene, wax, polyethylene terephthalate, polypropylene, polyethylene, polyurethane, polysulphone, polyethersulfone, polytetrafluoroethylene (PTFE), tetrafluoroethylene (TFE), fluorinated ethylenepropylene copolymer (FEP), polyvinylidene fluoride (PVDF), perfluoroalkoxyltetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), perfluoropolyether (PFPE), polychlorotetrafluoroethylene (PCTFE), polyvinyl alcohol (PVA), polyethyleneglycol (PEG), Tecnoflon cellulose acetate, poly(acrylic acid), poly(propylene oxide), D-sorbitol, polycarbonate, one or more members from the following list of Styrenic Block copolymers, including but not limited to, SEP: Polystyrene-b-poly(ethylene/propylene), SEPS: Polystyrene-b-poly(ethylene/propylene)-b-polystyrene, SEBS: Polystyrene-b-poly(ethylene/butylene)-b-polystyrene, SEEPS: Polystyrene-b-poly(ethylene-ethylene/propylene)-b-polystyrene, SIS: Styrene-Isoprene-Styrene; ethylene-propylene random copolymer (EPM), hydrogenated polybutadiene-isoprene-butadiene block copolymer, one or more members from the following list of Polyamide based thermoplastic elastomers, including but not limited to, Polyesteramides (PEA), Polyetheresteramides (PEEA), Polycarbonate esteramides (PCEA), Polyether-block-amides (PE-b-A); and polyacrylate based thermoplastic elastomers.

19. The elastomeric gel block of claim 12, wherein the impregnating liquid is selected from the group consisting of silicone oils, fluorinated hydrocarbons, fluorinated perfluoropolyethers, fluorinated silicones, aryl silicones, phenyl trimethicone, cyclomethicones, aryl cyclomethicones and hydrocarbon liquids including mineral oil, paraffin oil, C₁₃-C₁₄ isoparaffins, C₁₆-C₁₈ isoparaffins, di glyceride esters of citric acid, and triglyceride esters of citric acid, and tri alkyl esters of citric acid.

20. The elastomeric gel block of claim 12, wherein the impregnating liquid further comprises a component selected from an additive, interfacial modifier, and rheological modifier.

21. The elastomeric gel block of claim 12, wherein the elastomeric gel block lubricious surface exhibits one or more of
an adhesiveness of no more than 2.5 mJ when measured by texture analyzer;
a negative adhesive force of no more than 170 g when measured by texture analyzer; and
a tack time of no more than 1.0 seconds when measured by texture analyzer.

22. A closure or interconnect system comprising the elastomeric gel block having a lubricious surface of claim 12, wherein the closure or interconnect system is sealed with the elastomeric gel block having a lubricious surface and requires no more than 10 lbf (<44 N), or no more than 5 lbf (<22 N) to open the closure or interconnect system.
